(19) United States
(12) Patent Application Publication
(10) Pub. No.: US 2020/0252411 A1
(43) Pub. Date: Aug. 6, 2020

(54) ENTERPRISE SECURITY MANAGEMENT PACKET INSPECTION AND MONITORING

(71) Applicant: Unisys Corporation, Blue Bell, PA (US)

(72) Inventors: SARAH K. INFORZATO, Malvern, PA (US); LEMOINE D. KEIPER, III, Malvern, PA (US); JONATHAN P. DAVIS, Malvern, PA (US); KATHLEEN R. WILD, Malvern, PA (US); STEVEN L. RAJCAN, Malvern, PA (US); ZACHARY DREMANN, Malvern, PA (US); MICHAEL J. DIDOMENICO, Malvern, PA (US); JONATHAN E. SKILTON, Malvern, PA (US); COREY SCHOENFELD, Malvern, PA (US)

(21) Appl. No.: 16/268,221

(22) Filed: Feb. 5, 2019

(51) Int. Cl. H04L 29/06

(52) U.S. Cl. CPC H04L 63/1408; H04L 63/164; H04L 63/20

(57) ABSTRACT

Methods and systems for monitoring network data packets within a secure network are described. One method includes receiving, at a consumer endpoint, a data packet from a second endpoint, the data packet being encrypted with an encryption key associated with a packet auditing community of interest and having a routing header appended thereto, the routing header identifying the consumer endpoint. The method includes decrypting the data packet using the encryption key associated with the packet auditing community of interest, and removing at least a portion of the routing header identifying the consumer endpoint from the decrypted data packet. The method also includes performing at least one packet auditing operation on the decrypted data packet.

### BACKGROUND

Robust enterprise security software is complex. It often requires installation of specific security software packages at each trusted computer associated with the enterprise, as well as management of various profiles for each of a number of different types of users having differing roles. Furthermore, each server within an enterprise network will typically have a collection of allowed connections external to the network to be managed.

Enterprise computing networks are often distributed across a large number of locations and interconnected over various private and public communication networks, such as LAN systems at a particular location, and via public communications networks between enterprise locations. Such enterprise computing networks, due to the business needs of the enterprise, often require secure communication among those disparate locations.

Existing computing networks typically utilize an arrangement in which communications within a local network are transmitted using clear text, and use network appliances which manage encryption and communication between enterprise locations to allow for secure communications over public networks. In some cases, encryption or security can be applied within the enterprise as well, for securing data.

However, in environments where data security is particularly sensitive, additional levels of security may be applied. For example, in some cases different groups of individuals within an enterprise may require their data to be secured or obscured from other individuals within the same enterprise. In some instances, such entities may utilize localized security appliances, such as those implementing Stealth secured data and communications technology provided by Unisys Corporation of Blue Bell, Pa. Such systems provide additional security benefits by providing a security layer with which users are assigned to “communities of interest”, or COIs, which represent groups of users having common usage, data access, and endpoint access rights. Users outside of an assigned community of interest may lack access to data (as in typical network security or secured folder arrangements), and may also lack any accessibility or visibility into the existence of particular endpoints within a network. In some implementations of the Stealth secured data and communications technology, appliances installed within a network control communications and memberships among communities of interest, and manage authentication for endpoints that are accessed by various users.

Use of such security technologies, and in particular those which utilize on-location secure appliances such as Stealth, result in technical challenges for an enterprise. For example, intrusion detection systems cannot analyze network data once Stealth is installed because network traffic in a Stealth network can be encrypted using IPSec, blocked using Stealth community of interest (COI) filters, or implicitly blocked. This leads to difficulties in the ability to analyze traffic from a suspicious endpoint, and handle such traffic appropriately.

Accordingly, improvements in enterprise network traffic inspection and monitoring for such a secured enterprise network are desirable.

### SUMMARY

In summary, the present disclosure relates to methods and systems for selectively copying network traffic packets within an enterprise network utilizing secure data and communications technology for analysis at a consumer endpoint.

In a first aspect, a method of auditing network data packets within a secure network is described. The method includes receiving, at a consumer endpoint, packet data from a second endpoint, the packet data including at least a portion of a data packet, the packet data being encrypted with an encryption key associated with a packet auditing community of interest and having a routing header appended thereto, the routing header identifying the consumer endpoint. The method includes decrypting the packet data using the encryption key associated with the packet auditing community of interest, and removing at least a portion of the routing header identifying the consumer endpoint from the decrypted packet data. The method also includes performing at least one packet auditing operation on the decrypted packet data.

In a second aspect, a network data packet auditing system is disclosed. The system includes a consumer endpoint including a programmable circuit communicatively connected to a memory storing a data packet routing service. The data packet routing service, when executed by the programmable circuit, causes the consumer endpoint to: receive packet data from a second endpoint, the packet data including at least a portion of a data packet, the packet data being encrypted with an encryption key associated with a packet auditing community of interest and having a routing header appended thereto, the routing header identifying the consumer endpoint; decrypt the packet data using the encryption key associated with the packet auditing community of interest; remove at least a portion of the routing header identifying the consumer endpoint from the decrypted packet data; and perform at least one packet auditing operation on the decrypted packet data.

In a third aspect, an enterprise security management network data packet auditing system is disclosed. The system includes a secure application programming interface configured to receive messages to enable or disable network data packet auditing at any of a plurality of endpoints within an enterprise network including an enterprise security management system, and a database configured to store auditing configuration data. The system further includes an authorization server configured to enable or disable network data packet auditing on one or more of the plurality of endpoints within the enterprise network in response to messages received at the secure application programming interface. The endpoints may be configured to copy packet data, the packet data including at least a portion of one or more data packets, encrypt copied packet data with a common community of interest key, and send encrypted copied packet data to a consumer endpoint within the enterprise network in response to being enabled by the authorization server. The system further includes one or more consumer endpoints configured to decrypt encrypted copied packet data to form decrypted packet data.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic view of an enterprise network distributed across premises, representing an example network in which aspects of the present disclosure can be implemented.

FIG. 2 illustrates a distributed multi-host system in which aspects of the present disclosure can be implemented.

FIG. 3 is a schematic illustration of an example computing system in which aspects of the present disclosure can be implemented.

FIG. 4 is a flowchart of a method of managing and controlling packet inspection systems, according to an example implementation.

FIG. 5 is a flowchart of a method of managing and controlling packet monitoring systems within a secure network, according to an example implementation.

FIG. 6 is an example diagram of a packet inspection system implemented within a secure enterprise network, according to an example implementation.

FIG. 7 is an example diagram of a packet inspection system implemented within a secure enterprise network, according to a second example implementation.

FIG. 8 is an example diagram of a packet inspection system implemented within a secure enterprise network, according to a third example implementation.

FIG. 9 is an example diagram of a packet monitoring system implemented within a secure enterprise network, according to a fourth example implementation.

FIG. 10 is an example diagram of a packet monitoring system implemented within a secure enterprise network, according to a fifth example implementation.

FIG. 11 is a block diagram of a system for configuring a packet auditing system using an API exposed by an enterprise security management system showing a first sequence of messages being exchanged within the secure enterprise network, according to an example embodiment.

FIG. 12 is a block diagram of a system for configuring a packet auditing system using an API exposed by an enterprise security management system showing a second sequence of messages being exchanged within the secure enterprise network, according to an example embodiment.

FIG. 13 is a block diagram of a network interface of a computing system useable within a consumer endpoint that is utilized within a secure enterprise network for packet receipt, modification, and forwarding, according to a possible embodiment.

FIG. 14 is a flowchart of operations performed to selectably configure endpoints within a secure enterprise network for packet auditing, according to an example embodiment.

FIG. 15 is a message exchange sequence useable to enable packet copying and auditing at a newly-instantiated endpoint within an enterprise network, according to an example embodiment.

FIG. 16 is a message exchange sequence useable to enable packet copying and auditing at an existing endpoint within an enterprise network, according to an example embodiment.

FIG. 17 is a message exchange sequence useable to re-key an endpoint and enable packet auditing within an enterprise network, according to an example embodiment.

FIG. 18 is a message exchange sequence useable to reset an endpoint within an enterprise network, according to an example embodiment.

FIG. 19 is a message exchange sequence useable to disable packet copying and auditing at an endpoint within an enterprise network, according to an example embodiment.

FIG. 20 is a message exchange sequence useable to modify settings associated packet copying and auditing at an existing endpoint within an enterprise network, according to an example embodiment.

FIG. 21 is a flowchart of a method of updating and/or changing settings associated with packet auditing, according to example embodiments described herein.

FIG. 22 is a block diagram of a network interface of a computing system useable within a consumer endpoint that is utilized within a secure enterprise network for packet receipt, modification, and forwarding, according to a possible embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to an enterprise security method and system that can be used to assist in auditing enterprise network traffic. The methods and systems described herein allow for network endpoints having traffic that may be encrypted using IPSec, blocked using Stealth COI keys/filters, or implicitly blocked by Stealth software via distribution of different encryption keys, to selectively copy network data packets or their associated headers and metadata, and send the copied data packets or headers and metadata to a packet consumer endpoint to be analyzed either by a packet inspection system or a packet monitoring system. Such a system may be integrated into an enterprise management tool providing enterprise network-wide security. Such copied packets are encrypted when sent to the consumer endpoint for analysis, and may be sent in their entirety. The method and systems disclosed allow for packet inspection and/or monitoring to be optional, and activated on-demand for specific endpoints. Additionally, the systems and methods of the present disclosure provide additional capability for an enterprise security management system in utilizing existing intrusion detection systems and deep packet inspection.

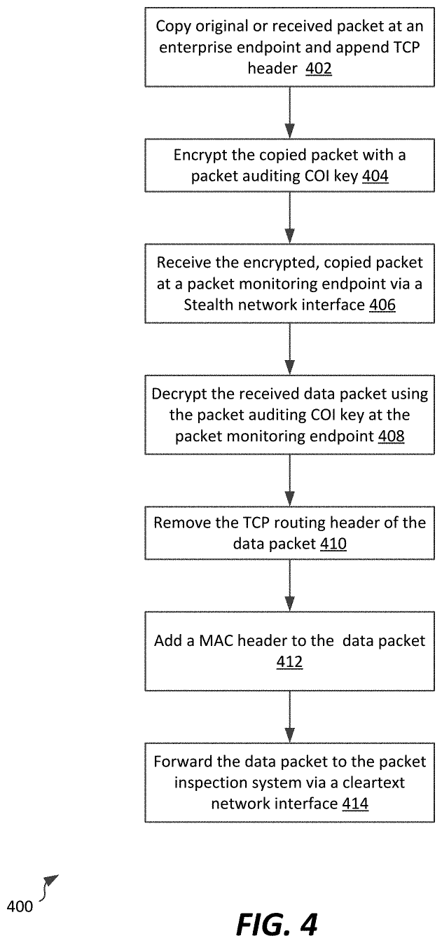

In the context of the present disclosure, packet auditing may refer to one or both of packet inspection and packet monitoring. In the examples below, packet inspection includes the copying of full data packets, encrypting the copied packets and sending them to a consumer endpoint for processing, and forwarding the processed packets to a packet inspection system which may be configured to analyze the data packets. In the examples below, packet monitoring includes copying portions of data packets, such as headers, appending predefined metadata to the headers, encrypting the portions of data packets and metadata and sending them to a consumer endpoint for processing and analysis by a packet monitoring system that may be implemented within the secure enterprise network. Packet auditing operations may include such analysis either at a packet inspection system or a packet monitoring system, and may also include any of the steps or elements described below in connection with FIGS. 4-22.

In the context of the present disclosure, packet data may refer to an entire data packet, or a portion of a data packet. In some examples, packet data includes only the header of a data packet, in other examples packet data includes only the header and other metadata included in a data packet. In still other examples, packet data includes the entire data packet, e.g. all of the header and the payload of a data packet. In other examples, packet data includes the entire data packet and any associated or appended metadata, and in still other examples packet data includes only the header and optionally other metadata included within the data packet along with any associated or appended metadata.

### I. Enterprise Security Configuration Server and Environment

By way of background, enterprises implementing security systems in which traffic among nodes within the enterprise network is secured must be configured using complex security policies that are coordinated to ensure that the various endpoints, or nodes, have access to various system resources that may be needed by that node or endpoint. One example of such a security system that can be implemented is the Stealth enterprise security solution from Unisys Corporation of Blue Bell, Pa. Generally, such a system is implemented using an enterprise management server that maintains security policies for various network endpoints, and distributes security policies to those endpoints, in terms of encryption keys that define communities of interest within the enterprise as well as filter lists identifying permitted and forbidden traffic patterns from each endpoint. One particular attribute of the Stealth solution is that for entities not included within a particular community of interest, the resource that is protected using that solution is not visible, and therefore would not be a hacking target (e.g., for DDoS attacks, or other types of attacks) given that its network address would not be known.

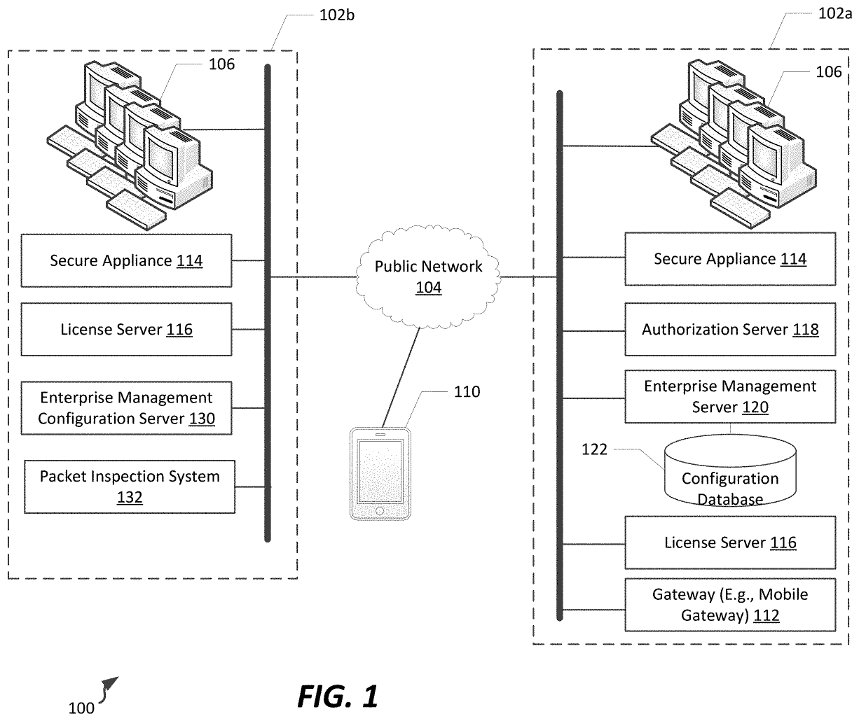

As noted above, solutions for creating enterprise security policies are complex. As such, an enterprise security configuration server is proposed to be included in example networks in which such security deployments are performed, which can create solutions for import into an enterprise server for distribution across an enterprise in a straightforward manner. FIGS. 1-3 illustrate example computing systems useable to implement an enterprise network and deploy security settings in such a network, while FIGS. 4-22 generally introduce the methods and systems for adding packet inspection and/or monitoring capability in an enterprise network implementing a security system, for example, the Stealth enterprise security system from Unisys Corporation of Blue Bell, Pa.

Referring now to FIG. 1, a schematic view of one example enterprise network 100 is illustrated. The enterprise network 100 is distributed across premises, and therefore includes at least a first premises 102a and a second premises 102b separated by a network 104, which can in some cases represent an at least partially public network, such as the Internet. The enterprise network 100 includes a plurality of endpoints 106. The endpoints 106 can be, for example, servers or workstations operable or accessible by a user to perform various tasks germane to the enterprise.

Users of such endpoints in this context may be associated with the enterprise and may be afforded access to computing resources at the endpoints 106; in such cases, different users may have different access rights to data or resources included in the enterprise. Accordingly, users are, via a management system, separated into defined communities of interest (COIs) which allows for common access rights to a group of users. The common access rights may be, in a corporate context, access rights associated with a particular department or project; in other contexts, access rights may be defined by a particular security clearance, membership in a particular group, or having a particular interest in common data or applications.

In the embodiment shown, each of the premises 102a-b have a plurality of endpoints 106 located within the premises. In such arrangements, the endpoints 106 can be interconnected at each of the premises using standard communications equipment (not shown) such as routers, switches, and cabling. In some embodiments, the endpoints 106 can be virtualized endpoints maintained on one or more servers. In such cases, one possible implementation of such an arrangement could be provided using s-Par® Secure Partitioning firmware provided by Unisys Corporation of Blue Bell, Pa. Other virtualization systems could be used as well.

It is noted that, in addition to endpoints 106 at premises 102a-b, other access mechanisms to the enterprise network 100 may be desirable as well. For example, in the embodiment shown a mobile device 110 may be used to access data or computing resources of the enterprise. In some embodiments, the mobile device 110 can establish a secure connection with a mobile gateway, such as gateway 112 which can act as a proxy for the mobile device 110 within the network, including receiving access to other endpoints within the network based on a community of interest of the user associated with the mobile device 110.

Referring to the premises 102a-b generally, it is noted that in some embodiments, each premises may include a secure appliance 114. The secure appliance can manage secure communications among endpoints 106 or between premises 102a-b. In example embodiments, the secure appliance 114 can be used to deliver encryption keys or encryption features (e.g., a driver with which endpoints can secure data for communication) for endpoints. In alternative embodiments, the secure appliance 114 may not be needed by some or all endpoints; in such arrangements, a native security feature, such as IPsec, could be used by the endpoints to ensure security within a premises 102, or between premises 102a-b generally. In such cases, encryption keys and standards can be defined centrally, for example using the management server described herein, to establish different keys and different communities of interest for use by the authorized users of endpoints across the premises 102a-b.

Additionally, in the embodiment shown, one or both premises 102a-b can include a license server 116. The license server 116 can manage and track license usage by the endpoints 106. For example one or more endpoints 106 may request a license to particular software or to a particular network resource. In such cases, the license server 116 can be contacted to grant or deny a license to such software or resource, based on a number of licenses available and whether the user of the endpoint is authorized to use such software or resource.

Additionally, in the embodiment shown, an authorization server 118 can be provided at one or more of the premises 102. The authorization server 118 can be accessed by an endpoint that is seeking authorization to access other resources within the network. Generally, the authorization server 118 can establish a secure communication session with that endpoint to provide authorization information (keys, settings, COI filters, etc.) to allow that endpoint to communicate with other endpoints within the network.

In addition to the above, a management server 120 (also referred to as an enterprise management server) is located at one of the premises 102a-b. The management server 120 provides a universally-accessible access location at which management settings can be viewed, enterprise access attempts logged, license tracking can be managed, and security arrangements defined, including definition of encryption policies, communities of interest, enterprise resources available, and other features. Additional details regarding operation of the management server are described in U.S. patent application Ser. No. 14/688,348, entitled ‘Enterprise Management for Secure Network Communications over IPSec” (Attorney Docket No. TN625), assigned to Unisys Corporation of Blue Bell, Pa., the disclosure of which is hereby incorporated by reference in its entirety.

Generally, the management server 120 is communicatively connected to a configuration database 122 (e.g., by hosting the configuration database or being communicatively connected to a separate computing system or systems that host that database). The configuration database generally stores configuration settings included in one or more configuration profiles for the enterprise network; and one or more interface definitions useable by the web interface to provide administrative access to the configuration settings. Details regarding the data stored in the configuration database are provided in U.S. patent application Ser. No. 14/688,348, entitled ‘Enterprise Management for Secure Network Communications over IPSec” (Attorney Docket No. TN625), the disclosure of which was previously incorporated by reference.

Enterprise management within the enterprise network 100 can be distributed among one or more of the management server 120, authorization server 118, license server 116, and secure appliance 114. Enterprise management provides the general management and control for servers using the Stealth security features of an enterprise network, and in particular Stealth installations that apply IPsec-based security. Each enterprise network, or enclave, can have a management instance that performs various user authentication, logging, licensing, certificate management, administration, web services, and software update features. Regarding authorization, the management service can ensure that a user is authenticated and authorized when logging on to the endpoint 106. The endpoint 106 receives an Authorization Token (AuthToken) that identifies the user's COI membership status.

The enterprise management server 120 hosts a management service that can also receive log information to be recorded, and can issue commands to the server to control its behavior or to request status information. This includes retrieving debugging information regarding security software installed through the enterprise. The management service also controls licensing, for example by installing a license System Control Number (SCN) and license values (strings) on a license host, such as either the management server 120 or the authorization server 118. Remote authorization servers, such as authorization server 118, communicate with a license host to share its licenses. The enterprise management server 120 also performs certificate management to maintain the certificates used for authentication.

Administrative users of the enterprise network 100, and management server 120 specifically, will use a GUI to control account management, role-based authorization, certificate management, and other administrative tasks. In some embodiments, a web services interface is provided to allow network access to management services. Additionally, the enterprise management features of the present disclosure are configurable to inventory levels of installed software and provide for software updates. This may include updates for endpoints as well as the management service itself. In some embodiments, the enterprise management server 120 can expose an Application Programming Interface (API) at which network security settings can be accessed and modified. Example uses of such an API are described below in conjunction with packet copying, forwarding, and inspection techniques.

In addition to the above, an enterprise management configuration server 130 can be included within the enterprise network 100. The enterprise management configuration server 130 generates a user interface at which security policies can be generated, for import into the management server 120 and configuration database 122. Although shown at premises 102b, it is understood that the enterprise management configuration server 130 could be located at a same location as the management server 120, or indeed be implemented on the same physical computing system as the management server 120, in alternative implementations.

In general, although the enterprise network 100 as shown is disclosed as having a plurality of premises 102a-b and a single management server 120, it is noted that other arrangements may exist in which management servers 120 can be distributed at one or more distributed locations, each of which are configured to communicate with an instance of the configuration database 122. Furthermore, one or more of those management servers 120 can be maintained as a redundant management server that is accessed in the event of failure of a primary management server. Additionally, since the management server 120 can be, in some embodiments, implemented as a process that executes within a computing environment, functionality of the management server can be combined with that of other systems on a single computing system or separated onto different computing systems; in some embodiments, a user interface server, management server, authorization server, license server, and/or other enterprise network security services can be located on separate servers, while in other embodiments two or more of these services can be combined on a single device (e.g., a discrete physical computing device or a virtual computing device installed on a partition of a physical computing device). Accordingly, enterprise management configuration server 130 can be configured to distribute security policy configurations to one or more management servers 120, or different security policies (or portions of a common security policy, as discussed further below) to different management servers.

In example embodiments, and in accordance with the present disclosure, the enterprise network 100 can include a packet inspection system 132. The packet inspection system 132 may be implemented as a third party packet inspection device, such as are available from Palo Alto Networks of Santa Clara, Calif.

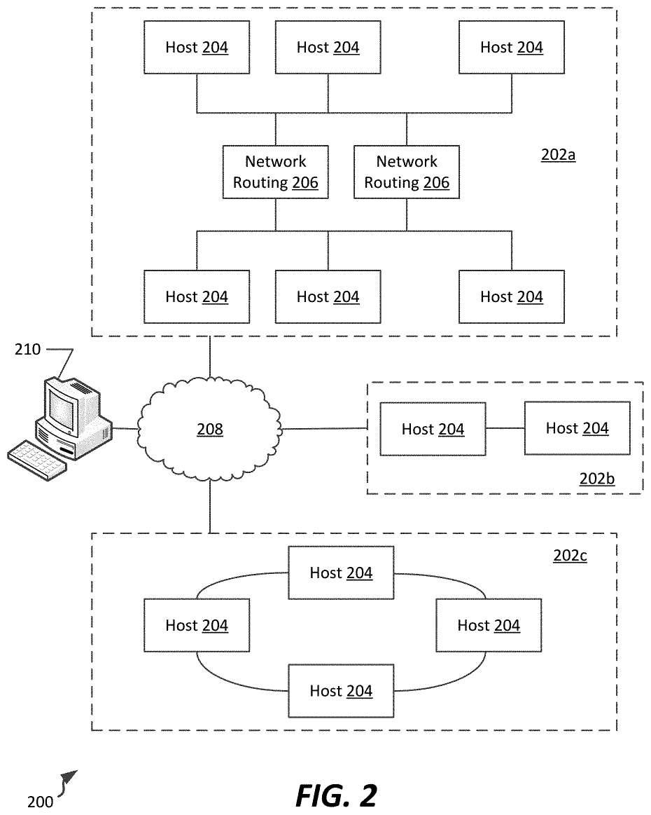

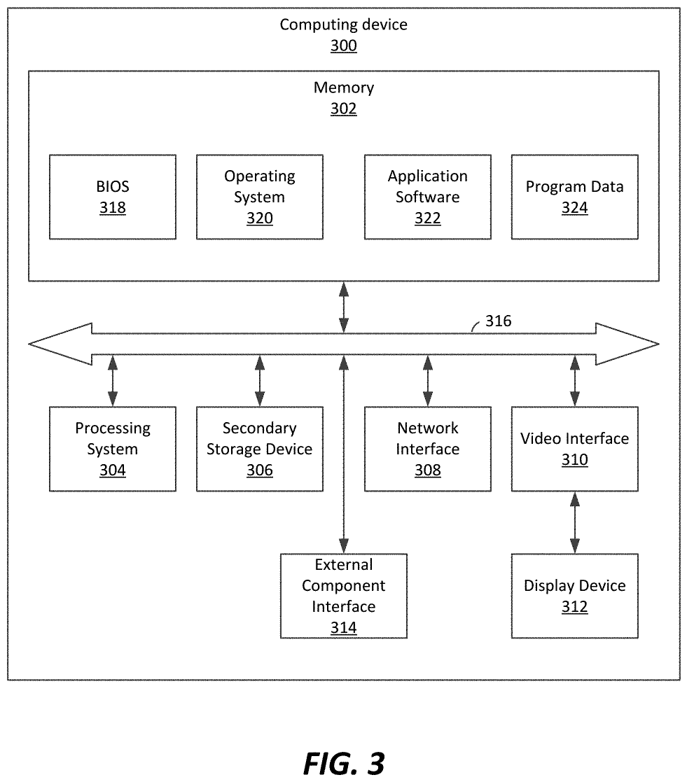

Referring now to FIG. 2, a distributed multi-host system 200 is shown in which aspects of the present disclosure can be implemented. The system 200 represents a possible arrangement of computing systems or virtual computing systems useable to implement the enterprise network of FIG. 1. In the embodiment shown, the system 200 is distributed across one or more locations 202, shown as locations 202a-c. These can correspond to locations remote from each other, such as a data center owned or controlled by an organization, a third-party managed computing cluster used in a “cloud” computing arrangement, or other local or remote computing resources residing within a trusted grouping. In the embodiment shown, the locations 202a-c each include one or more host systems 204, or nodes. The host systems 204 represent host computing systems, and can take any of a number of forms. For example, the host systems 204 can be server computing systems having one or more processing cores and memory subsystems and are useable for large-scale computing tasks. In one example embodiment, a host system 204 can be as illustrated in FIG. 3.

As illustrated in FIG. 2, a location 202 within the system 200 can be organized in a variety of ways. In the embodiment shown, a first location 202a includes network routing equipment 206, which routes communication traffic among the various hosts 204, for example in a switched network configuration. Second location 202b illustrates a peer-to-peer arrangement of host systems. Third location 202c illustrates a ring arrangement in which messages and/or data can be passed among the host computing systems themselves, which provide the routing of messages. Other types of networked arrangements could be used as well.

In various embodiments, at each location 202, the host systems 204 are interconnected by a high-speed, high-bandwidth interconnect, thereby minimizing latency due to data transfers between host systems. In an example embodiment, the interconnect can be provided by an IP-based network; in alternative embodiments, other types of interconnect technologies, such as an Infiniband switched fabric communications link, Fibre Channel, PCI Express, Serial ATA, or other interconnect could be used as well.

Among the locations 202a-c, a variety of communication technologies can also be used to provide communicative connections of host systems 204 at different locations. For example, a packet-switched networking arrangement, such as via the Internet 208, could be used. Preferably, the interconnections among locations 202a-c are provided on a high-bandwidth connection, such as a fiber optic communication connection.

In the embodiment shown, the various host system 204 at locations 202a-c can be accessed by a client computing system 210 such as the endpoints 106 of FIG. 1. The client computing system can be any of a variety of desktop or mobile computing systems, such as a desktop, laptop, tablet, smartphone, or other type of user computing system. In alternative embodiments, the client computing system 210 can correspond to a server not forming a cooperative part of the para-virtualization system described herein, but rather which accesses data hosted on such a system. It is of course noted that various virtualized partitions within a para-virtualization system could also host applications accessible to a user and correspond to client systems as well.

It is noted that, in various embodiments, different arrangements of host systems 204 within the overall system 200 can be used; for example, different host systems 204 may have different numbers or types of processing cores, and different capacity and type of memory and/or caching subsystems could be implemented in different ones of the host system 204. Furthermore, one or more different types of communicative interconnect technologies might be used in the different locations 202a-c, or within a particular location.

Referring now to FIG. 3, a schematic illustration of an example discrete computing system in which aspects of the present disclosure can be implemented. The computing device 300 can represent, for example, a native computing system within which one or more of servers 116-120, 130 can be implemented, or an implementation of an endpoint 106, or mobile device 110 (a.k.a., nodes), or an implementation of the packet inspection system 132. In particular, the computing device 300 represents the physical construct of an example computing system at which an endpoint or server could be established. In some embodiments, the computing device 300 implements virtualized or hosted systems, and executes one particular instruction set architecture while being used to execute non-native software and/or translate non-native code streams in an adaptive manner, for execution in accordance with the methods and systems described herein.

In the example of FIG. 3, the computing device 300 includes a memory 302, a processing system 304, a secondary storage device 306, a network interface 308, a video interface 310, a display unit 312, an external component interface 314, and a communication medium 316. The memory 302 includes one or more computer storage media capable of storing data and/or instructions. In different embodiments, the memory 302 is implemented in different ways. For example, the memory 302 can be implemented using various types of computer storage media.

The processing system 304 includes one or more processing units. A processing unit is a physical device or article of manufacture comprising one or more integrated circuits that selectively execute software instructions. In various embodiments, the processing system 304 is implemented in various ways. For example, the processing system 304 can be implemented as one or more physical or logical processing cores. In another example, the processing system 304 can include one or more separate microprocessors. In yet another example embodiment, the processing system 304 can include an application-specific integrated circuit (ASIC) that provides specific functionality. In yet another example, the processing system 304 provides specific functionality by using an ASIC and by executing computer-executable instructions.

The secondary storage device 306 includes one or more computer storage media. The secondary storage device 306 stores data and software instructions not directly accessible by the processing system 304. In other words, the processing system 304 performs an I/O operation to retrieve data and/or software instructions from the secondary storage device 306. In various embodiments, the secondary storage device 306 includes various types of computer storage media. For example, the secondary storage device 306 can include one or more magnetic disks, magnetic tape drives, optical discs, solid state memory devices, and/or other types of computer storage media.

The network interface 308 enables the computing device 300 to send data to and receive data from a communication network. In different embodiments, the network interface 308 is implemented in different ways. For example, the network interface 308 can be implemented as an Ethernet interface, a token-ring network interface, a fiber optic network interface, a wireless network interface (e.g., WiFi, WiMax, etc.), or another type of network interface. In some embodiments, the network interface 308 may be implemented as multiple network interfaces of the same or different type.

The video interface 310 enables the computing device 300 to output video information to the display unit 312. The display unit 312 can be various types of devices for displaying video information, such as an LCD display panel, a plasma screen display panel, a touch-sensitive display panel, an LED screen, a cathode-ray tube display, or a projector. The video interface 310 can communicate with the display unit 312 in various ways, such as via a Universal Serial Bus (USB) connector, a VGA connector, a digital visual interface (DVI) connector, an S-Video connector, a High-Definition Multimedia Interface (HDMI) interface, a wireless or headless video interface, or a DisplayPort connector.

The external component interface 314 enables the computing device 300 to communicate with external devices. For example, the external component interface 314 can be a USB interface, a FireWire interface, a serial port interface, a parallel port interface, a PS/2 interface, any of the video interfaces discussed above in connection with video interface 310, and/or another type of interface that enables the computing device 300 to communicate with external devices. In various embodiments, the external component interface 314 enables the computing device 300 to communicate with various external components, such as external storage devices, input devices, speakers, modems, displays, media player docks, other computing devices, scanners, digital cameras, and fingerprint readers.

The communication medium 316 facilitates communication among the hardware components of the computing device 300. In the example of FIG. 3, the communications medium 316 facilitates communication among the memory 302, the processing system 304, the secondary storage device 306, the network interface 308, the video interface 310, and the external component interface 314. The communications medium 316 can be implemented in various ways. For example, the communications medium 316 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

The memory 302 stores various types of data and/or software instructions. For instance, in the example of FIG. 3, the memory 302 stores a Basic Input/Output System (BIOS) 318 and an operating system 320. The BIOS 318 includes a set of computer-executable instructions that, when executed by the processing system 304, cause the computing device 300 to boot up. The operating system 320 includes a set of computer-executable instructions that, when executed by the processing system 304, cause the computing device 300 to provide an operating system that coordinates the activities and sharing of resources of the computing device 300. Furthermore, the memory 302 stores application software 322. The application software 322 includes computer-executable instructions, that when executed by the processing system 304, cause the computing device 300 to provide one or more applications. The memory 302 also stores program data 324. The program data 324 is data used by programs that execute on the computing device 300. The program data 324 can be used, for example, to perform packet auditing operations such as described herein and below, in connection with FIGS. 4-22.

Although particular features are discussed herein as included within a computing device 300, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. Computer storage media does not include a carrier wave or other propagated or modulated data signal. In some embodiments, the computer storage media includes at least some tangible features; in many embodiments, the computer storage media includes entirely non-transitory components.

It is noted that, although in the embodiments of FIG. 3 shown the computing device 300 represents a physical computing system, the various endpoints and servers of the present disclosure need not be directly implemented on a hardware-compatible system. Rather, such endpoints or servers could be implemented within a virtual computing system or virtual partition of a computing system. In some embodiments, the endpoints and/or servers of the present disclosure are implemented in a partitioned, multiprocessor environment, with the various partitions in which endpoints and/or servers reside being managed by a system virtualization software package. One such system virtualization package is the Unisys Secure Partitioning (s-Par®) partitioning and virtualization system provided by Unisys Corporation of Blue Bell, Pa.

In general the endpoints of the present disclosure can be configured various ways, with registry settings selected to configure the endpoint to communicate according to an appropriate communication protocol. In some example embodiments, each IPv6-based system includes a capability to communicate with the authorization server via either IPv4 or IPv6 communications. Other administrator-selected IP-based protocols could be used as well.

### II. Packet Inspection and Monitoring (Packet Auditing)

Now referring now to FIGS. 4-22, details regarding methods and systems for adding packet auditing capability in an enterprise network implementing a security system are provided. In general, the enterprise security management system described above can be used to selectively audit packets or portions of packets that are sent from or received by secured endpoints within an enterprise network. For example, an administrative user can access the enterprise management server via an application programming interface (API) to selectively enable packet copying and forwarding for auditing, and a consumer endpoint can receive such copied packets and process those packets for forwarding to an intrusion detection system, for example, the packet inspection system 132 of FIG. 1, for analysis and storage. Dedicated encryption can be provided for secure packet forwarding to such consumer endpoints, which can modify headers of copied packets prior to forwarding to the intrusion detection system. Additionally, packets may be forwarded to the consumer endpoint at a rate configurable via the API, or portions of packets (e.g., headers and metadata) may be forwarded for auditing, providing improved flexibility of auditing within a network that would otherwise have only encrypted data (whether suspect or not), and would therefore be difficult to audit.

In the context of the present disclosure, packet auditing may refer to one or both of packet inspection and packet monitoring. In the examples below, packet inspection includes the copying of full data packets, encrypting the copied packets and sending them to a consumer endpoint for processing, and forwarding the processed packets to a packet inspection system which may be configured to analyze the data packets. In the examples below, packet monitoring includes copying portions of data packets, such as headers, appending predefined metadata to the headers, encrypting the portions of data packets and metadata and sending them to a consumer endpoint for processing and analysis by a packet monitoring system that may be implemented within the secure enterprise network. Packet auditing operations may include such analysis either at a packet inspection system or a packet monitoring system, and may also include any of the steps or elements described below in connection with FIGS. 4-22.

In the context of the present disclosure, packet data may refer to an entire data packet, or a portion of a data packet. In some examples, packet data includes only the header of a data packet, in other examples packet data includes only the header and other metadata included in a data packet. In still other examples, packet data includes the entire data packet, e.g. all of the header and the payload of a data packet. In other examples, packet data includes the entire data packet and any associated or appended metadata, and in still other examples packet data includes only the header and optionally other metadata included within the data packet along with any associated or appended metadata.

FIG. 4 is a flowchart of a method 400 of managing and controlling packet inspection systems, according to an example implementation. In general, the method 400 includes selectively copying network data packets and sending them to a consumer endpoint for processing and analysis by an inspection system, according to an example embodiment of the present disclosure. The method 400 can be performed, for example, at an enterprise security management configuration server, such as server 130 of FIG. 1, or at an enterprise security management server, such as server 120 of FIG. 1, or at any endpoint 106 of FIG. 1.

In the example shown, the method 400 includes copying an original network data traffic packet at an endpoint, e.g. a packet that originated at that endpoint, or copying a received packet at an endpoint, at step 402. In some embodiments, the originating packet, or received packet, may be sent over a secure communication session using authorization information, such as a COI key and/or filters, to another endpoint. In some embodiments, the copied packet has a transmission control protocol (TCP) routing header appended to the packet for transmission using a low level TCP socket.

At step 404 the copied packet is encrypted using a packet auditing COI key. In some embodiments, a plurality of packets may be copied at the endpoint and encrypted using the packet auditing COI key. In some embodiments, the plurality of packets may include data transmitted or received according to a plurality of communication protocols, for example, TCP/IP, UDP, ICMP, or any other transmission protocol. At step 406, the encrypted, copied packet is sent to a consumer endpoint, which receives the encrypted, copied packet at a secure network interface, for example, a Stealth network interface. At step 408, the packet is decrypted using the packet auditing COI key, and at step 410 the TCP routing header is removed from the copied packet.

In the example shown, the method 400 includes adding a media access control (MAC) header to the packet at step 412. In some embodiments, the MAC header includes the MAC address of the consumer endpoint and a destination MAC address. At step 414, the encapsulated packet is written to the local network interface. The IP header of this packet is not routable on the network, but the MAC header allows the packet to be sent to an inspection system via a dedicated clear text communication interface.

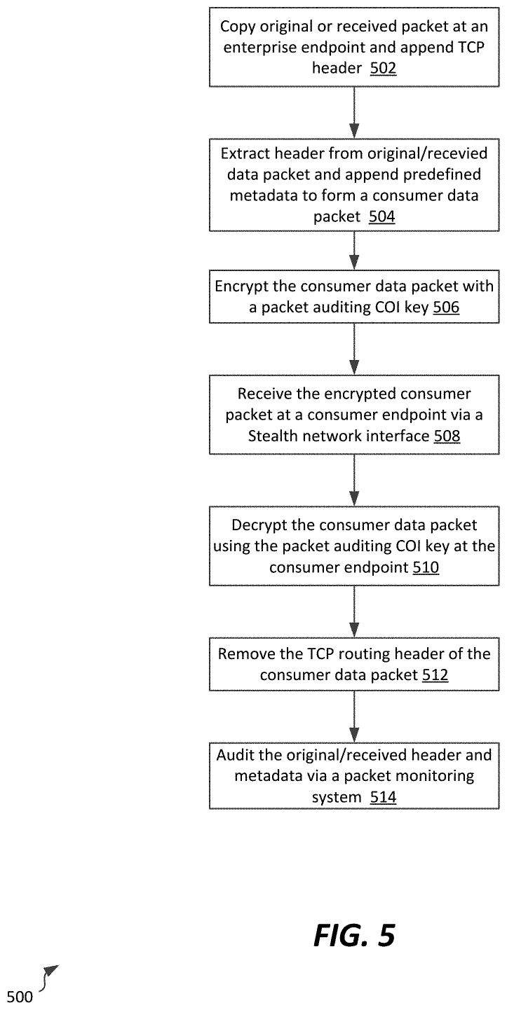

FIG. 5 is a flowchart of a method 500 for managing and controlling packet monitoring systems within a secure network, according to an example implementation. In general, the method 500 includes selectively copying network data packets and sending at least portions of the copied data packets, such as headers and metadata, to a consumer endpoint for processing and analysis by a packet monitoring system, according to an example embodiment of the present disclosure. The method 500 can be performed, for example, at an enterprise security management configuration server, such as server 130 of FIG. 1, or at an enterprise security management server, such as server 120 of FIG. 1, or at any endpoint 106 of FIG. 1.

In the example shown, the method 500 includes copying an original network data traffic packet at an endpoint, e.g. a packet that originated at that endpoint, or copying a received packet at an endpoint, at step 502. In some embodiments, the originating packet, or received packet, may be sent over a secure communication session using authorization information, such as a COI key, to another endpoint. In some embodiments, the copied packet has a transmission control protocol (TCP) routing header appended to the packet for transmission using a low level TCP socket.

In the example shown, the method 500 includes forming a consumer data packet to be sent to a consumer endpoint by extracting the header from the original or received data packet and appending predefined metadata at step 504. In some embodiments, the header and metadata for multiple original or received data packets can be collected and transmitted in a single consumer data packet. In some embodiments, the same packet header may result on both the outbound and inbound endpoints, but the metadata for the header will indicate the direction of the original or received data packet when it was captured and/or copied.

At step 506 the consumer data packet is encrypted using a packet auditing COI key. In some embodiments, a plurality of original or received data packets may be copied at the endpoint, and their associated headers and predefined metadata included encrypted in a single consumer data packet using the packet auditing COI key. In some embodiments, the plurality of original or received packets may include data transmitted or received according to a plurality of communication protocols, for example, TCP/IP, UDP, ICMP, or any other transmission protocol. At step 508, the encrypted consumer packet is sent to a consumer endpoint, which receives the encrypted consumer data packet at a secure network interface, for example, a Stealth network interface. At step 510, the consumer data packet is decrypted using the packet auditing COI key, and at step 512 the TCP routing header is removed from the consumer data packet.

In the example shown, the method 500 includes auditing the original or received data packet headers and predefined metadata, using a packet monitoring system. In some embodiments, the packet monitoring system is included within the secure enterprise network security management system, such as a Stealth network, and resides on the packet monitoring remote endpoint.

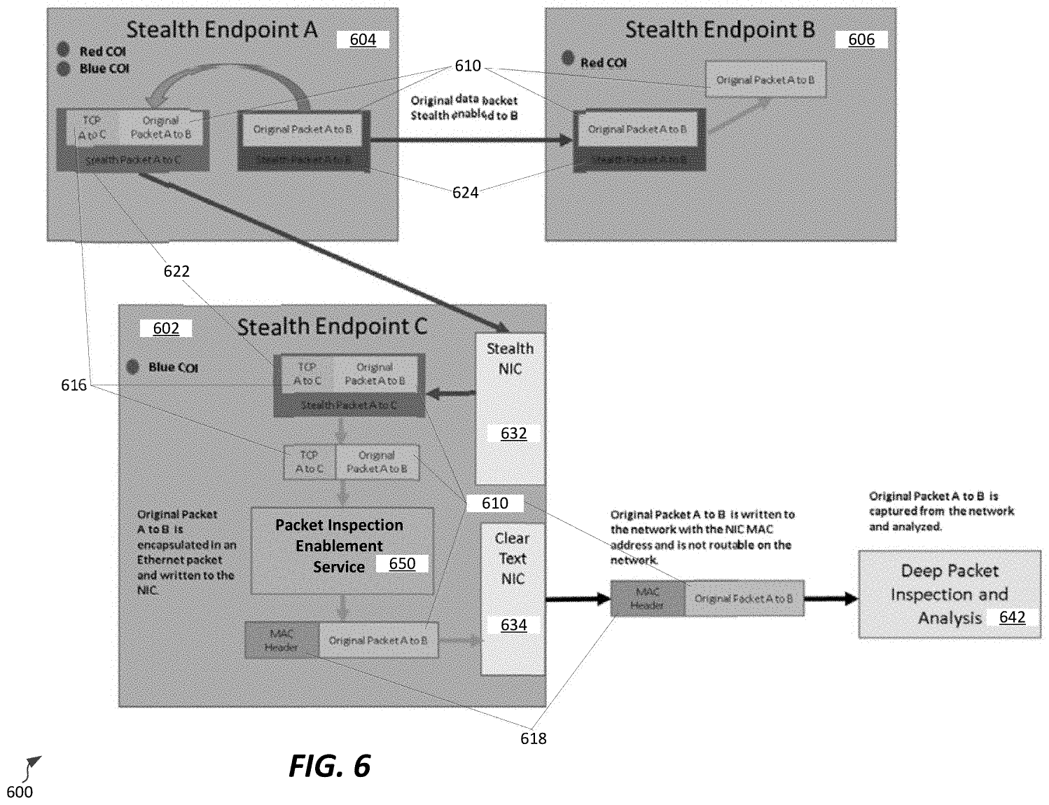

FIG. 6 illustrates an example block diagram of a packet inspection system 600 implemented within a secure enterprise network, according to an example implementation. In the example shown, system 600 includes consumer endpoint 602. In some embodiments, consumer endpoint 602 may be a remote endpoint. In other embodiments, consumer endpoint 602 may be a management server, such as server 120 of FIG. 1. In the example shown, system 600 also includes endpoints 604 and 606. Endpoints 604 and 606 may be located at an enterprise network premises, such as premises 102a-b, or may be remote. Endpoints 604 and 606 can be, for example, servers or workstations such as endpoints 106 of FIG. 1. Endpoints, 604 and 606 can also be mobile devices, such as mobile device 110 of FIG. 1.

In the context of system 600, the endpoints 604, 606 are configured to provide packet inspection, for example by being configured by an enterprise security management server. Selection to enable or disable packet copying, forwarding, and inspection may be done at the enterprise security management server via access by an administrative user, for example via an API exposed by that server. Other arrangements are possible as well, as discussed further below.

In the example shown, endpoint 604 is the originating endpoint of a data packet 610 and is configured to be able to selectively copy data packets that it sends or receives, endpoint 606 is the receiving endpoint of data packet 610, and both endpoint 604 and 606 are a part of a community of interest in relation to the data being sent between the two, e.g. data packet 610 to be sent from endpoint 604 to endpoint 606. As such, system 600 includes COI key 624, and in the example shown, data packet 610 is encrypted using COI key 624 and then is sent to endpoint 606, which may decrypt the information using its corresponding COI key 624. In some embodiments, both endpoints 604 and 606 are configured to selectively copy data packets to be sent to consumer endpoint 602. In some embodiments, system 600 includes a plurality of either, or all, of consumer endpoint 602 and endpoints 604 and 606.

In the example shown, data packet 610 is transmitted by a TCP protocol, however, any protocol can be used. System 600 also includes TCP routing header 616 and packet auditing COI key 622. In the example shown, data packet 610 is copied at endpoint 604, the TCP routing header 616 is appended to the data packet 610 for sending the packet via TCP over the network to consumer endpoint 602. Data packet 610 is then encrypted using packet auditing COI key 622 and sent via TCP to consumer endpoint 602.

In the example shown, consumer endpoint 602 includes a secure enterprise network interface 632, such as a Stealth network interface, a local network interface, such as clear text interface 634, and a packet inspection enablement service 650. System 600 also includes a packet inspection system 642, e.g. the packet inspection system 132 of FIG. 1. In the example shown, the encrypted data packet 610 is received by the consumer endpoint 602 at the secure enterprise network interface 632, and the consumer endpoint 602 then uses its corresponding packet auditing COI key 622 to decrypt the encrypted data packet 610. The packet inspection enablement service 650 on the consumer endpoint 602 then processes the data packet 610. In the example shown, the processing includes removing the TCP header 616 from the data packet 610, and encapsulating the data packet 610 in an Ethernet frame by adding a MAC header 618. In the example shown, the data packet 610 is sent via a clear text interface 634.

In some embodiments, the packet inspection system 642 resides on an endpoint within the secured enterprise network, either within a premises, such as premises 102a-b, or on a remote endpoint. In other embodiments, the packet inspection service 642 is external to the secured enterprise network. In some embodiments, packet inspection system 642 includes the architecture for full packet inspection, including data, and meets the requirements for Deep Packet Inspection. In the example shown in system 600, the IP header of processed data packet 618 is not routable on the network, but the added MAC header allows the packet to be analyzed by the packet inspection system 642.

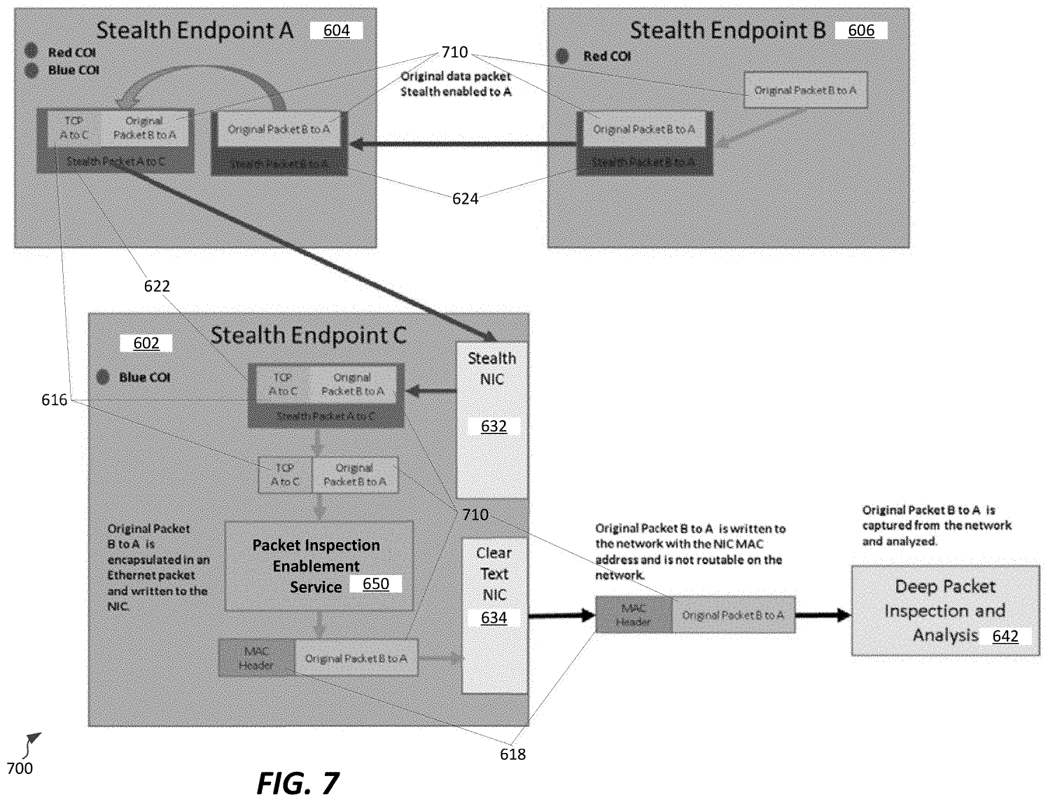

FIG. 7 illustrates an example block diagram of a packet inspection system 700, implemented within a secure enterprise network according to a second example implementation. In the example shown, system 700 includes consumer endpoint 602, endpoint 604 that is configured to selectively copy packets to be sent to the consumer endpoint 602, endpoint 606, and packet inspection system 642. System 700 is similar to system 600, the difference being that the data packet 710 to be copied and inspected originates at endpoint 606 and is sent to endpoint 604, which is the endpoint that sends the encrypted data packet 710 to the consumer endpoint 602. In some embodiments, either one or both of endpoints 604 and 606 are configured to be able to selectively copy and send data packets to consumer endpoint 602.

In the example shown, and similar to system 600 above, both endpoints 604 and 606 are a part of a community of interest in relation to the data being sent between the two, e.g. data packet 710 to be sent from endpoint 606 to endpoint 604. As such, system 700 includes COI key 624 for encrypting data packets sent to endpoint 604.

In the example shown, and similar to system 600 above, data packet 710 may be transmitted by a TCP protocol, however, any protocol can be used. System 700 also includes TCP routing header 616 and packet auditing COI key 622. In the example shown, data packet 710 is copied at endpoint 604, the TCP routing header 616 is appended to the data packet 710 for sending via TCP over the network to consumer endpoint 602. Data packet 710 is then encrypted using packet auditing COI key 622 and sent via TCP to consumer endpoint 602.

In the example shown, and similar to system 600 above, consumer endpoint 602 includes a secure enterprise network interface 632, such as a Stealth network interface, a local network interface, such as clear text interface 634, and a packet inspection enablement service 650. Consumer endpoint 602 may use its corresponding packet auditing COI key 622 to decrypt the encrypted data packet 710, and the packet inspection enablement service 650 may process data packet 710 similarly to data packet 610 above, namely, the data packet 710 may be encapsulated in an Ethernet frame by adding a MAC header 618. In the example shown, the data packet 710 is sent via clear text interface 634.

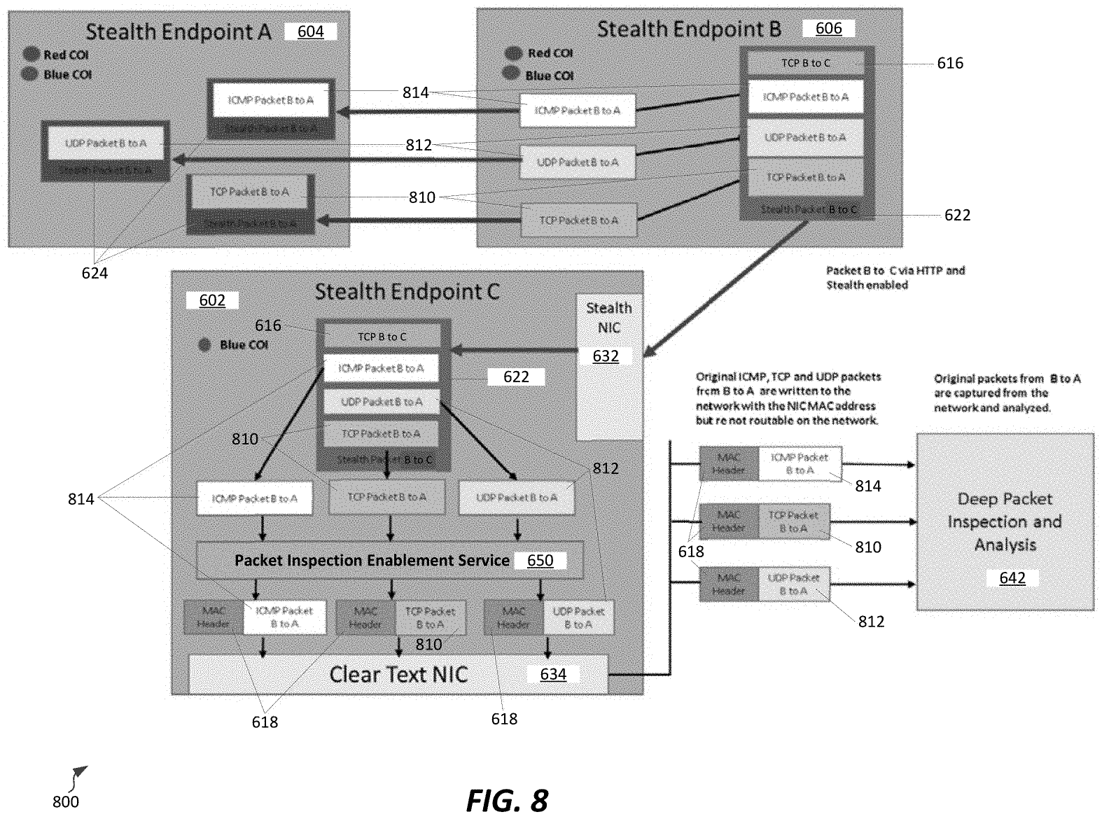

FIG. 8 illustrates an example block diagram of a packet inspection system 800 implemented within a secure enterprise network, according to a third example implementation. In the example shown, system 800 includes consumer endpoint 602, endpoint 604, endpoint 606, and packet inspection system 642.

In the example shown, endpoint 606 is configured to selectively copy data packets to be sent to consumer endpoint 602. In the example shown in system 800, both endpoints 604 and 606 are a part of a community of interest in relation to the data being sent between the two, e.g. data packet 810 to be sent from endpoint 606 to endpoint 604, similar to systems 600 and 700 above. As such, system 800 includes COI key 624 for encrypting data packets sent to endpoint 604.

In the example shown, system 800 includes multiple data packets, e.g. data packets 810, 812, and 814, each containing data to be sent via multiple communication protocols. Data packet 810 contains data to be sent via TCP, data packet 812 contains data to be sent via UDP, and data packet 814 contains data to be sent via ICMP. Although system 800 illustrates three data packets each having a different communication protocol, one of ordinary skill in the art can appreciate that fewer or more data packets, each having the same or different communication protocols, is within the scope of the present disclosure. It may also be appreciated that although in the example shown three communication protocols are illustrated, data packets utilizing any communication protocol are within the scope of the present disclosure.

In the example shown, system 800 includes COI key 624 as mentioned above. Each of data packets 810, 812, and 814 may be encrypted using COI key 624 and sent to endpoint 604.

In the example shown, data packets 810, 812, and 814 may be transmitted by a TCP protocol, however, any protocol can be used. System 800 also includes TCP routing header 616 and packet auditing COI key 622. In the example shown, data packets 810, 812, and 814 are copied at endpoint 606, the TCP routing header 616 is appended to the copied data packets 810, 812, and 814 for sending via TCP over the network to consumer endpoint 602. Copied data packets 810, 812, and 814 are then encrypted using packet auditing COI key 622 and sent via TCP to consumer endpoint 602.

In the example shown, and similar to systems 600 and 700 above, consumer endpoint 602 includes a secure enterprise network interface 632, such as a Stealth network interface, a local network interface, such as clear text interface 634, and a packet inspection enablement service 650. The consumer endpoint 602 may use its corresponding packet auditing COI key 622 to decrypt the encrypted data packets 810, 812, and 814, and the data packets 810, 812, and 814 may each be processed similarly to data packets 610 and 710 in systems 600 and 700, respectively, with each of data packets 810, 812, and 814 being encapsulated in an Ethernet frame by having the MAC header 618 added. In the example shown, the data packets 810, 812, and 814 are sent via clear text interface 634.

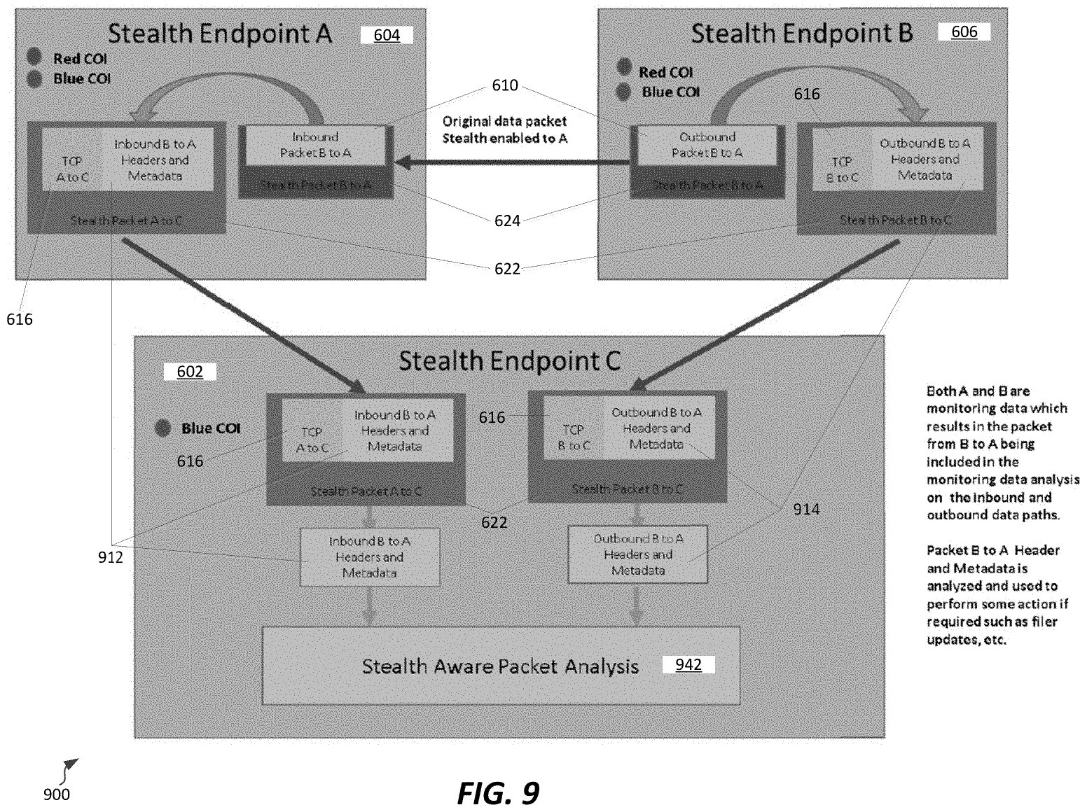

FIG. 9 illustrates an example block diagram of a packet monitoring system 900 implemented within a secure enterprise network, according to a fourth example implementation. In the example shown, system 900 includes consumer endpoint 602, endpoint 604, endpoint 606, and packet monitoring system 942. In the example shown in system 900, both endpoints 604 and 606 are a part of a community of interest in relation to the data being sent between the two, e.g. data packet 610 to be sent from endpoint 606 to endpoint 604. As such, system 900 includes COI key 624 for encrypting data packets sent to endpoint 604.

In the example shown, the header from data packet 610 is copied and stored at both endpoints 604 (from the received data packet) and 606 (from the originating data packet), along with some predefined metadata. In the example shown, both the received data packet header and metadata 912 at endpoint 604 and the original packet header and metadata 914 at endpoint 606 may be transmitted by a TCP protocol, however, any protocol can be used. System 900 also includes TCP routing header 616 and packet auditing COI key 622. In the example shown, the TCP routing header 616 is appended to the original and received data packet headers and metadata 912 and 914 at each endpoint 604 and 606 for sending via TCP over the network to consumer endpoint 602. The received and original data packet headers and metadata 912 and 914 are then encrypted using packet auditing COI key 622 and sent via TCP to consumer endpoint 602.

In the example shown, consumer endpoint 602 includes a packet monitoring system 942. The received and original data packet headers and metadata 912 and 914 are decrypted using COI key 622. The received and original data packet headers and metadata 912 and 914 are analyzed by the packet monitoring system 942, and may be used to perform an action if required, for example, filter updates. In the example shown, monitoring is shown on both endpoints 604 and 606, resulting in both received and original packet headers and metadata 912 and 914 having the same header information. However, the metadata for the each header will indicate the direction of the data packet when it was captured. In some embodiments, either one or both of received and original data packet headers and metadata 912 and 914 are formed.

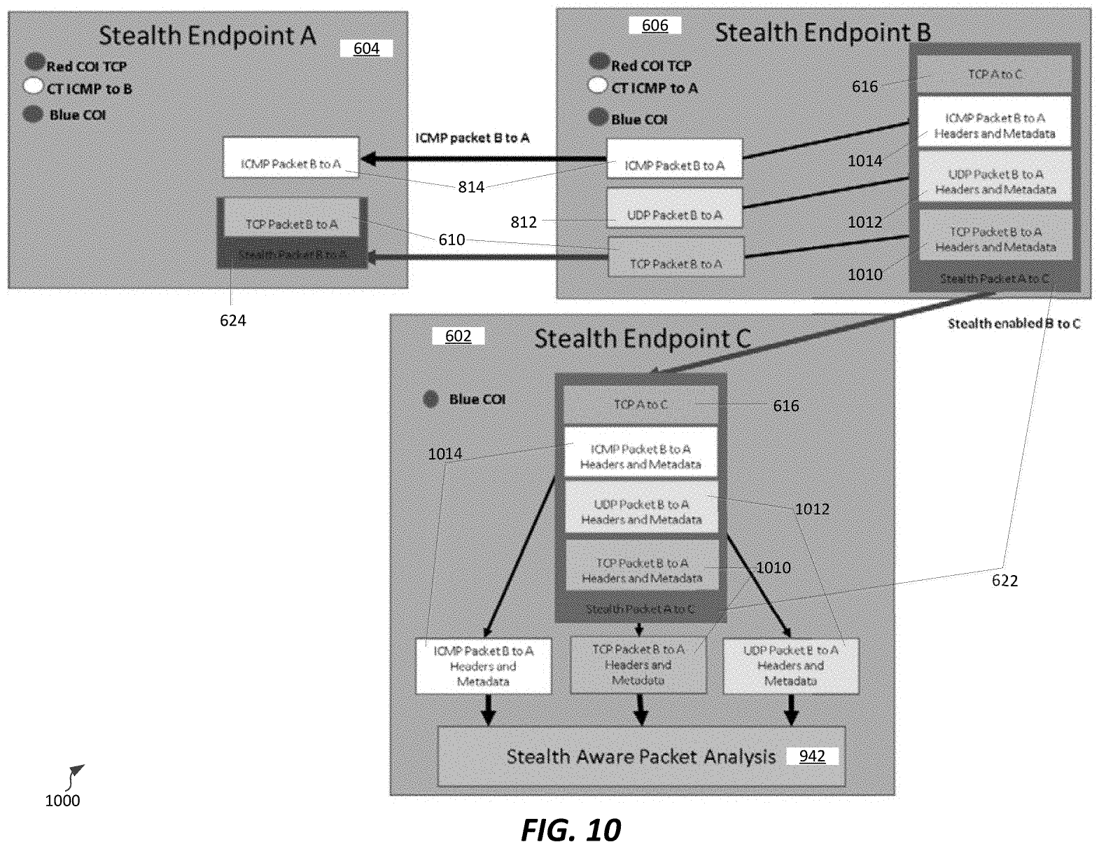

FIG. 10 illustrates an example block diagram of a packet monitoring system 1000 implemented within a secure enterprise network, according to a fifth example implementation. In the example shown, system 1000 includes consumer endpoint 602, endpoint 604, endpoint 606, and packet monitoring system 942.

In the example show, endpoint 604 includes TCP data packet 610, UDP packet 812, and ICMP data packet 814. TCP packet 610 is Stealth data, e.g. data sent via a Stealth tunnel and is encrypted using COI key 624. UDP packet 812 is blocked by endpoint 604 and not received, and ICMP data packet 814 is sent via clear text. In other words, data packet 610 is sent across the Stealth tunnel, which also has a filter to allow only TCP traffic in addition to COI key 624. Data packet 812 is blocked and discarded by endpoint 604. Endpoint 606 may also include clear text filters for ICMP traffic to endpoint 604.

In the example shown, the headers from data packets 610, 812, and 814 are collected along with predefined metadata forming packet headers and metadata 1010, 1012, and 1014, respectively. The metadata indicates the type of data, e.g. Stealth, blocked, or clear text, and can be used to determine potential modifications to the COI and/or filtering in the Stealth network.

In the example shown, system 1000 also includes TCP routing header 616 which is appended to packet headers and metadata 1010, 1012, and 1014 for sending via TCP over the network to consumer endpoint 602. The packet headers and metadata 1010, 1012, and 1014 are then encrypted using packet auditing COI key 622 and sent via TCP to consumer endpoint 602.

In the example shown, consumer endpoint 602 includes a packet monitoring system 942. The packet headers and metadata 1010, 1012, and 1014 are decrypted using COI key 622. The packet headers and metadata 1010, 1012, and 1014 are analyzed by the packet monitoring system 942, and may be used to perform an action if required, for example, filter updates. In the example shown, the metadata for each header will indicate the communication protocol associated with the respective packet header, e.g. clear text, ICMP traffic, blocked UDP traffic, and Stealth TCP traffic.

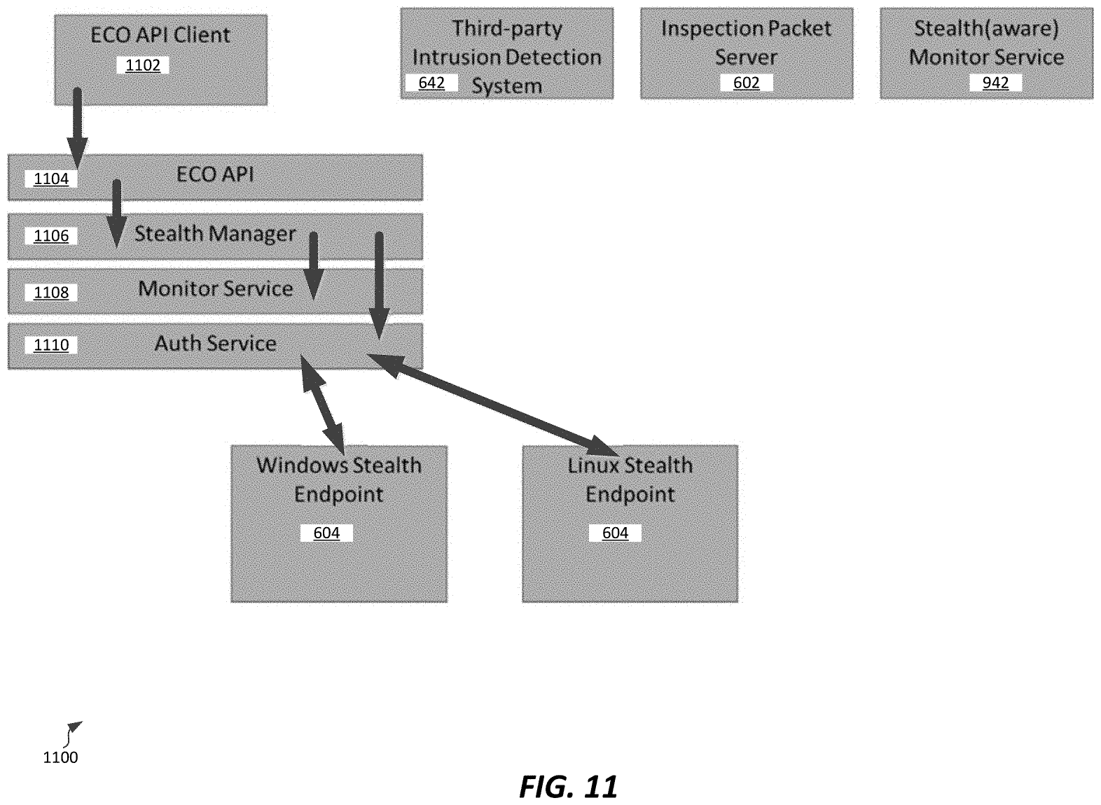

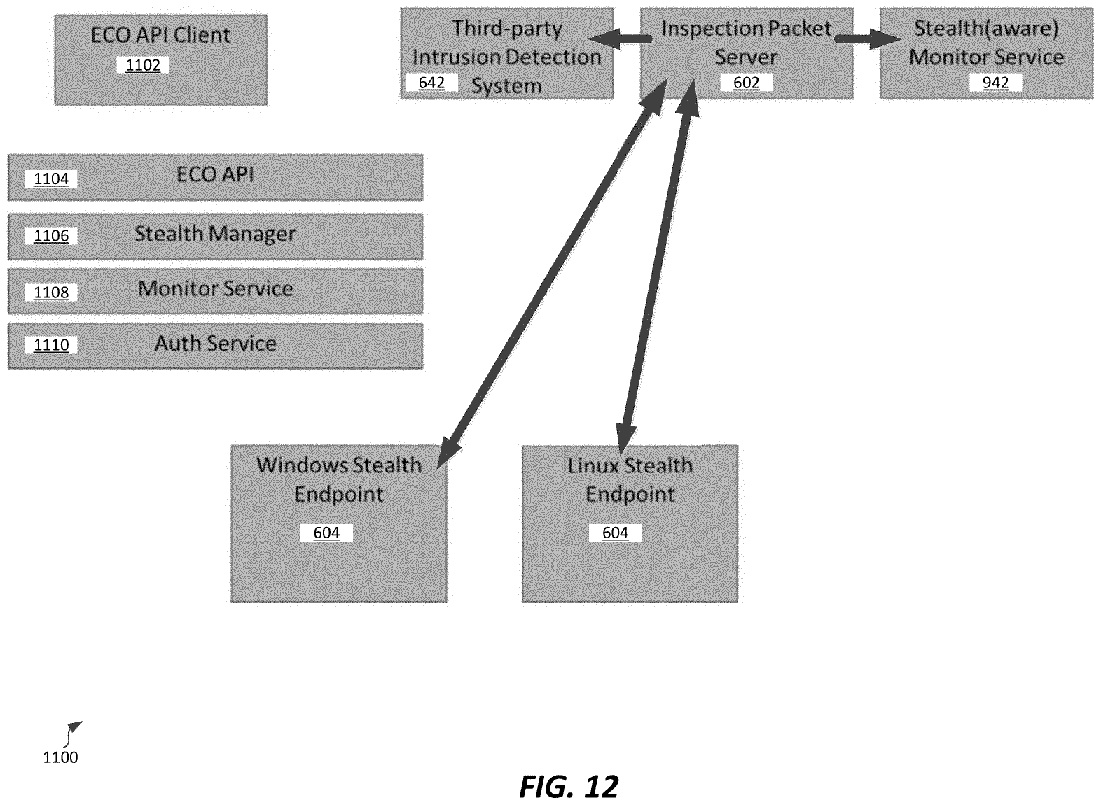

FIGS. 11 and 12 illustrate example block diagrams of systems for configuring a packet auditing system using an API exposed by an enterprise security management system showing sequences of messages being exchanged within the secure enterprise network, according to an example embodiment. Referring to FIG. 11, in the example shown, system 1100 includes consumer endpoint 602, endpoint(s) 604, packet inspection system 642, packet monitoring system 942, client extensible component orchestrator application programming interface (ECO API) 1102, ECO API 1104, enterprise management component 1106, monitor service 1108, and authorization service 1110. In some embodiments, enterprise management component 1106 can be a Stealth manager for a Stealth network with consumer endpoint 602 and endpoint(s) 604 being Stealth enabled. In some embodiments, system 1100 includes a plurality of consumer endpoints 602 and endpoints 604.

In the example shown, the client ECO API 1102 includes the user interface for enabling and disabling packet auditing, and the ECO API 1104 is the secure interface used to enable or disable packet auditing. The ECO API 1104 provides an interface by which administrative users can access and configure settings at endpoints within the enterprise via the enterprise management component 1106, which stores and maintains the current set of auditing configuration data. The enterprise management component 1106 can therefore be implemented using server 120 and configuration databases 122, as described above in connection with FIG. 1. In the example shown, the enterprise management component 1106 communicates to the authorization service 1110 to enable or disable packet auditing on endpoint(s) 604. In some embodiments, the communication between authorization service 1110 and endpoint(s) 604 may be implemented via Stealth endpoint sessions. In some embodiments, monitoring system 1100 may include a plurality of authorization services 1110.

Referring to FIG. 12, in the example shown, endpoint(s) 604 delivers packets to consumer endpoint 602. The communications between endpoint(s) 604 and consumer endpoint 602 must be secure, and in some embodiments are Stealth enabled. The consumer endpoint processes the packets, e.g. as described above in connection with FIGS. 4-10, and delivers them to either packet inspection system 642 if packet inspection is enabled, or packet monitoring system 942 if packet monitoring is enabled.

In some embodiments, the consumer endpoint 602 has two network interfaces, a Stealth interface connected to the Stealth network, and a clear text interface connected to the packet inspection system 642 and configured without an IP address.

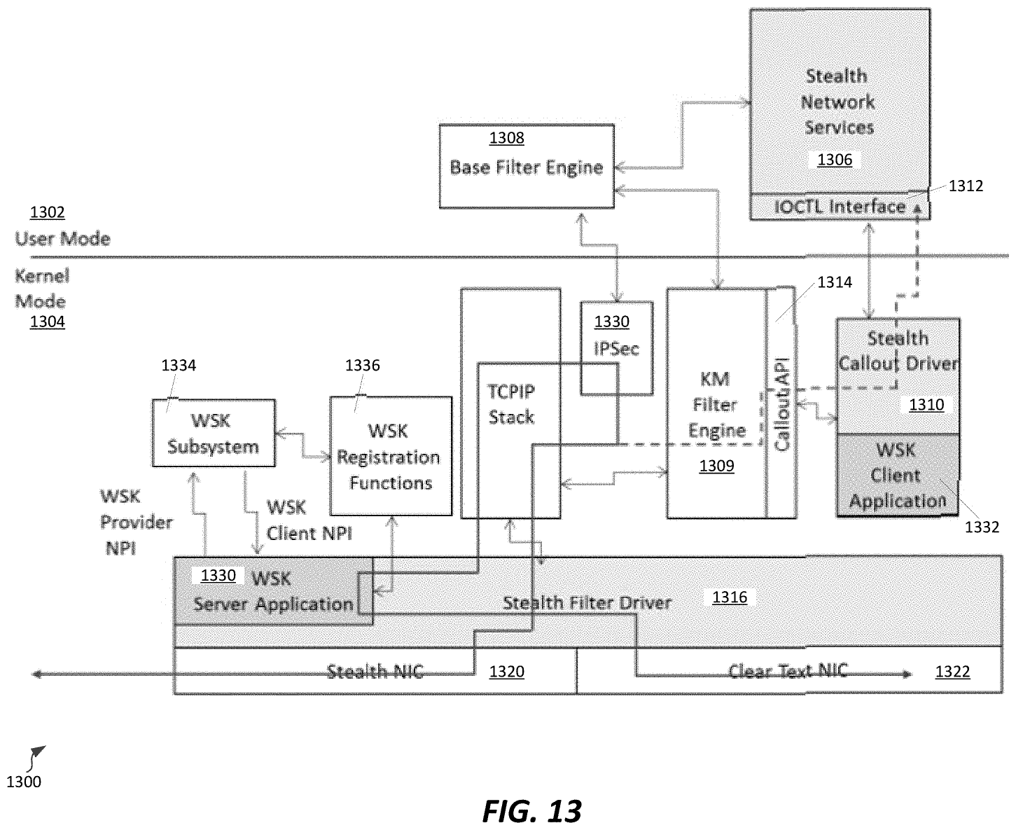

FIG. 13 illustrates an example block diagrams of a network interface 1300 of a computing system useable within a consumer endpoint that is utilized within a secure enterprise network for packet receipt, modification, and forwarding, according to a possible embodiment. The computing system can be, for example, an endpoint, such as one of the computing systems described in FIGS. 1-3. In some embodiments of the present disclosure, the methods and systems discussed herein use the Windows Filtering Platform (WFP), an architecture provided in Windows Vista operating systems and above. In other embodiments, the methods and systems discussed herein may use the architecture provided by other operating systems, e.g. Linux. The WFP allows for filtering, monitoring and/or modification of TCP/IP packets as well as filtering of IPSec traffic. The WFP allows for access to TCP/IP processing at different layers and can be used to filter on incoming or outgoing traffic. In the embodiment shown, a user mode 1302 and kernel mode 1304 are shown, with a user level service 1306 that creates one or more WFP filters, and directs a native base filter engine 1308 to use IPSec for specific endpoint to endpoint traffic. In the embodiment shown, the filter engine 1308 can also include a kernel mode filter engine component 1309. p A callout driver 1310, interconnected to the user level service 1306 by an input/output control (IOCTL) interface 1312, is used to identify new endpoints that require the establishment of a Stealth tunnel. The callout driver 1310 interfaces to a callout API 1314, which defines the kernel mode interface to the kernel mode filter engine component 1309.

The callout driver 1310 is used to interface with the WFP, which is generally native in the Windows operating system of the system on which it is installed. The callout driver 1310 sits above the MLSTP filter driver 1316 and is also used to intercept all traffic based on how filters are configured in the WFP. The callout driver 1310 is a Kernel level WFP callout driver. WFP callout drivers provide functionality that extend the capabilities of the Windows Filtering Platform. Callouts allow the callout driver 1310 to examine network data in order to determine if/when an IPsec-based tunnel should be established. In some embodiments, the callout driver 1310 is automatically started during system startup, and interfaces with the user level service 1306 via a set IOCTL calls.

During service start up or initiation of a Stealth connection, the user level service 1306 adds a provider and sublayer to the WFP system, and adds associated callouts with initial filters to the system (for both IPv4 and IPv6). An initial group of filters are added to allow traffic such as loopback, IPv4 subnet broadcast, IPv6 neighbor discovery, as well as protocol datagram units (PDUs) used to control the IPsec tunnels. An additional filter is added to the system so that all other traffic is called out for further examination by the callout driver 1310. The callout driver 1310 enables secure processing by registering the callouts with the filter engine (e.g., via kernel mode filter engine component 1309), to intercept inbound or outbound connect attempts. In some embodiments, the callout driver 1310 intercepts inbound and outbound connections and transport layer traffic sent to or received from remote peers and queues the packets to a worker thread for processing.

The callout driver 1310 maintains a structure for each remote endpoint it is communicating with, along with a global linked list of such endpoint connections. In some embodiments, a global hash table is maintained within the call out driver 1310 to help search for a connection. Each endpoint connection entry in the list tracks pending connections or accepted received connection requests, and a packet queue that wait for an IPSec tunnel to be established. Once the IPSec tunnel is established by the login service, the callout driver 1310 completes the pending operation and/or reinjects the packets back into the data path. The user level service 1306 sets up the IPSec tunnel such that once it is established, the driver callouts will no longer be invoked for data on this connection.

In general, the callout driver 1310 performs a process for each packet that is received at the endpoint. Generally, the callout driver 1310 will permit the packet if it was already previously inspected, or block the packet if the service is not initialized or there are no Global Service Events available (e.g., for sending IOCTLs to the user level service 1306 to handle the received packet). The callout driver 1310 will then search its hash table, and create an entry. If a Stealth tunnel (IPsec or MLSTP) is already open, the packet is permitted. Otherwise the packet is initialized to be reinserted at a later time, and added to a connection list or packet queue, and the callout driver 1310 then informs the user level service 1306 to initialize a tunnel to the remote endpoint identified by the remote IP address.

In the example shown, the MLSTP filter driver 1316 is enhanced to provide the capability to accept mirrored traffic from a client, such as endpoints 604 and 606, using a Windows Socket Kernel (WSK). A kernel level socket is used to improve performance by removing the transition from kernel level to user level. A packet inspection system, such as packet inspection system 642, provides the server socket and processes inbound packets, such as from consumer endpoint 602. The client socket is implemented in the callout driver 1310, allowing it to buffer and transmit data directly from kernel level memory. The MLSTP filter driver 1316 implements the socket server application 1330 and collects monitor messages from the client socket, e.g. consumer endpoint 602, parses them into individual data packets and retransmits them via the clear text network interface 1322 using a predefined destination MAC address. A WSK registration component 1336 and WSK subsystem component 1334 are in communication with the socket server application 1330. The callout driver 1310 also implements the socket client application 1332.

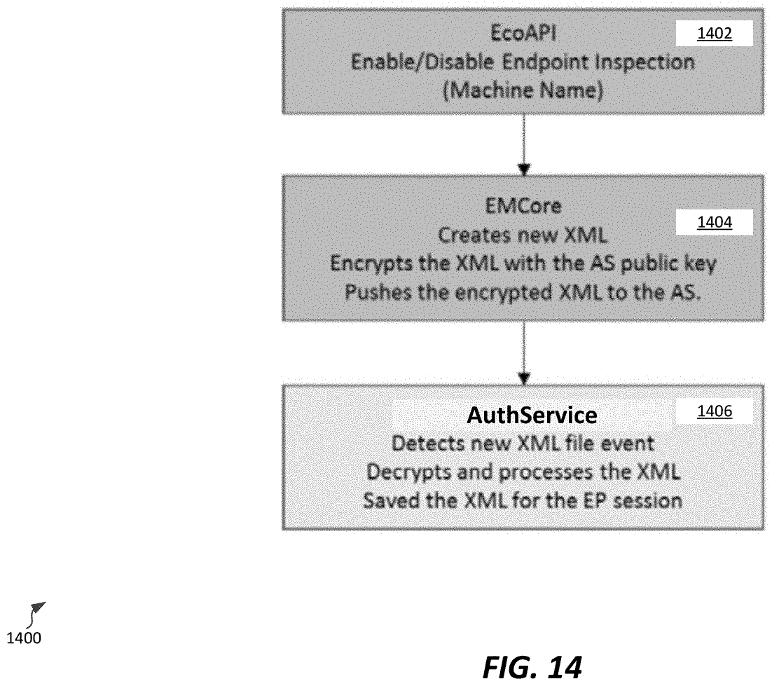

FIG. 14 is a flowchart of a method 1400 including operations performed to selectably configure endpoints within a secure enterprise network for packet auditing, according to an example embodiment. At step 1402, the ECO API 1104 is the interface used to securely enable or disable endpoint inspection, and receives a user request to enable or disable packet auditing on specific endpoints, e.g. endpoints 604 or 606. In the example shown, the ECO API 1104 sends a request for a packet auditing change to the enterprise management component 1106, for example the fully qualified domain name (FQDN) of the endpoint on which to enable or disable packet auditing. In example embodiments, an administrative user can also use the ECO API 1104 to define parameters for monitoring and/or inspection, including, e.g., whether to inspect all packets or some portion of packets, or some portion of each packet (e.g., headers). The ECO API also allows the administrative user to define a rate at which packets are provided for inspection, e.g., to packet inspection systems.

At step 1404, the enterprise management component 1106 creates a monitor XML with the current/updated endpoint list and sends the monitor XML to all authorization services 1110. The monitor XML includes an element that defines all machine names for the endpoints on which auditing is enabled, e.g., on which auditing attributes are set, and an element that defines the inspection XML for each endpoint. The XML also includes a section that fully defines all the information needed to send the packets directly from the endpoint to the consumer endpoint 602, for example, the name of the consumer endpoint 602, and IP addresses and ports. The monitor XML is encrypted with the authorization service 1110 public key, and the enterprise management component 1108 pushes the monitor XML to the authorization service 1110. At step 1406, the authorization service 1406 receives the monitor XML, decrypts it, and processes the XML.

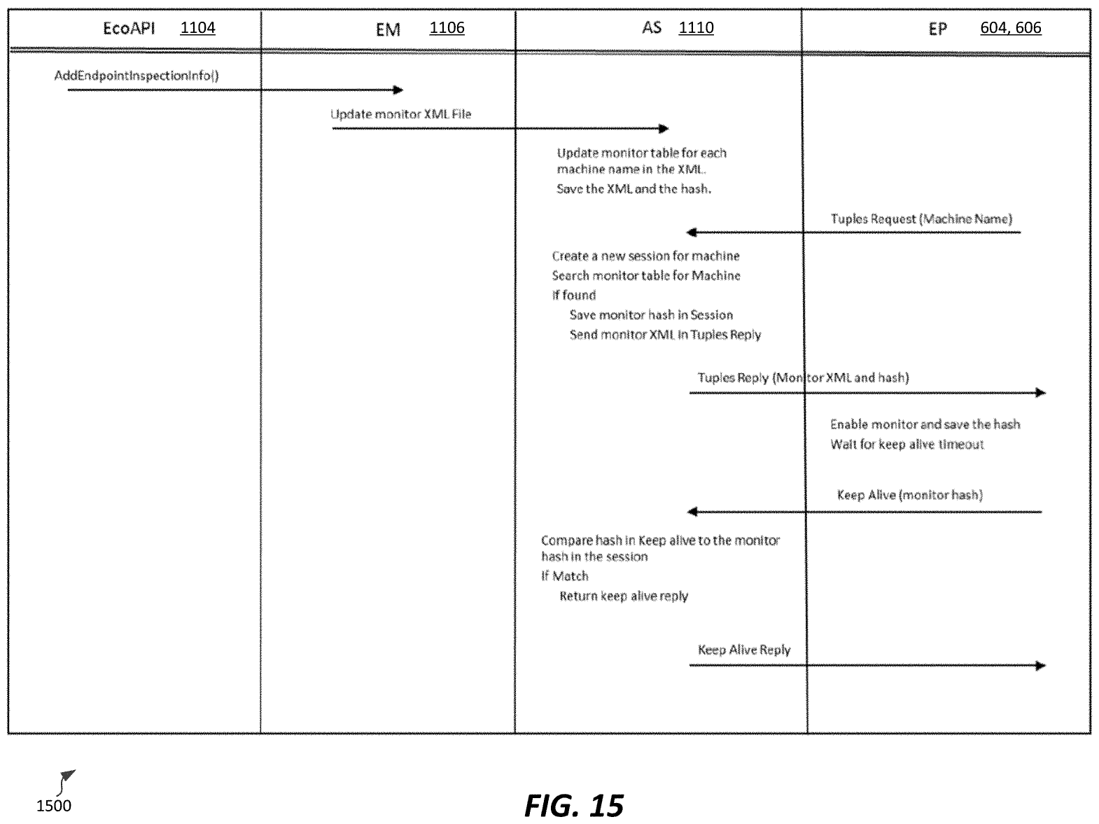

Referring now to FIGS. 15-20, various message flows are shown illustrating packet auditing enabling on new endpoint sessions, existing endpoint sessions, with rekeying, with resetting, inspection and monitor disabling, and updating XML attributes once monitoring or inspection has been enabled. FIG. 15 is a message exchange sequence 1500 useable to enable packet copying and auditing at a newly-instantiated endpoint within an enterprise network, according to an example embodiment. In the example shown, the ECO API 1104 invokes an add inspection endpoint routine (AddEndpointInspectionInfo) using the machine name for the endpoint to be enabled. The enterprise management component 1106 receives the command to enable auditing on the endpoint and generates the monitor XML, which defines parameters of the inspection process. The enterprise management component 1106 pushes this XML to every known authorization service 1110. The authorization service 1110 receives a signal indicating a new/updated monitor XML is available. The authorization service 1110 reads the new XML and stores the monitor attributes for each endpoint in its internal table. Every time the monitor XML is added or updated, the authorization service 1110 processes the new monitor XML. For example, the authorization service 1110 may clear the monitor hash from all of its active sessions and second, and find sessions associated with each machine name in the XML. In such cases, the authorization service 1110 adds the monitor hash to that session. Accordingly, after the new monitor XML is processed, in such implementations, only sessions associated with the current set of monitor endpoints will have non-null monitor hash values and sessions that have been removed have null monitor hash values. If the endpoint does not yet have a session, when the endpoint does issue a tuples request the request includes the machine name. When the tuples request is received by the authorization service 1110, the authorization service 1110 knows that it has an active monitor table and uses the machine name to check the monitor table and determine if the new endpoint machine has an entry in the table. If it finds a match, it retrieves the monitor XML, saves the hash value for the XML in the new session for this endpoint and returns the monitor XML (including the hash value) to the endpoint in the Tuples Reply message. The endpoint finds the monitor XML in the Tuples Reply, parses the monitor XML, saves the hash and enables monitoring using the attributes specified in the XML. Once auditing is enabled on the endpoint, the endpoint includes the monitor hash value in every keep alive request is sends to the authorization service 1110 until monitoring is disabled.

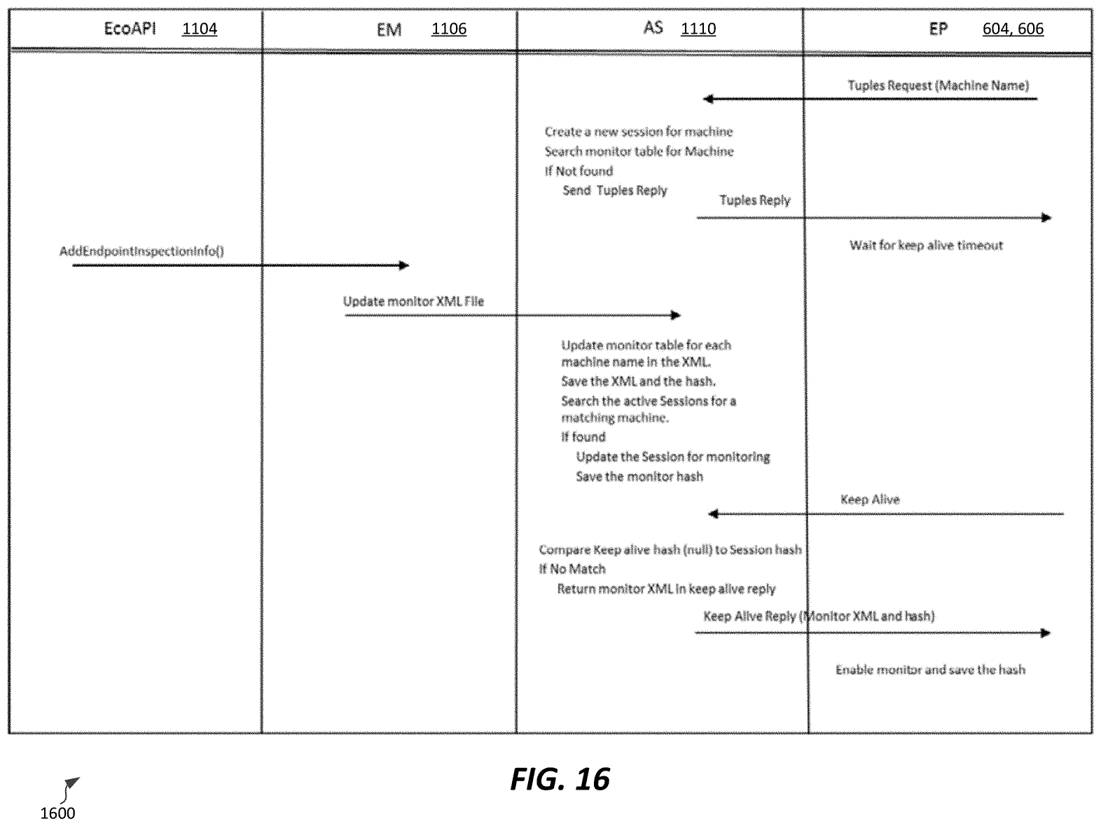

FIG. 16 is a message exchange sequence 1600 useable to enable packet copying and auditing at an existing endpoint within an enterprise network, according to an example embodiment. In the example shown, the AddEndpointInspectionInfo routine is issued from the API while the endpoint is in operation, and monitoring is invoked on the endpoint machine name after the endpoint has already been authorized. In the example shown, the authorization service 1110 follows the same steps of clearing the monitor hash from all of its active sessions and adding the monitor hash to sessions associated with each endpoint machine name in the XML, which results in all of its existing sessions being updated with the new monitor hash. Because the session is active, the authorization service 1110 waits for the next keep alive message from the endpoint. When the keep alive arrives, the authorization service 1110 compares the hash in the keep alive with the hash in the endpoint session and determines that they do not match. As a result, the authorization service 1110 adds the monitor XML for the endpoint to the keep alive reply message. The endpoint enables monitoring, saves the hash and returns the hash in all future keep alive requests. The updated keep alive message, including the relevant monitor XML, is provided to the endpoint, which is then enabled for monitoring.

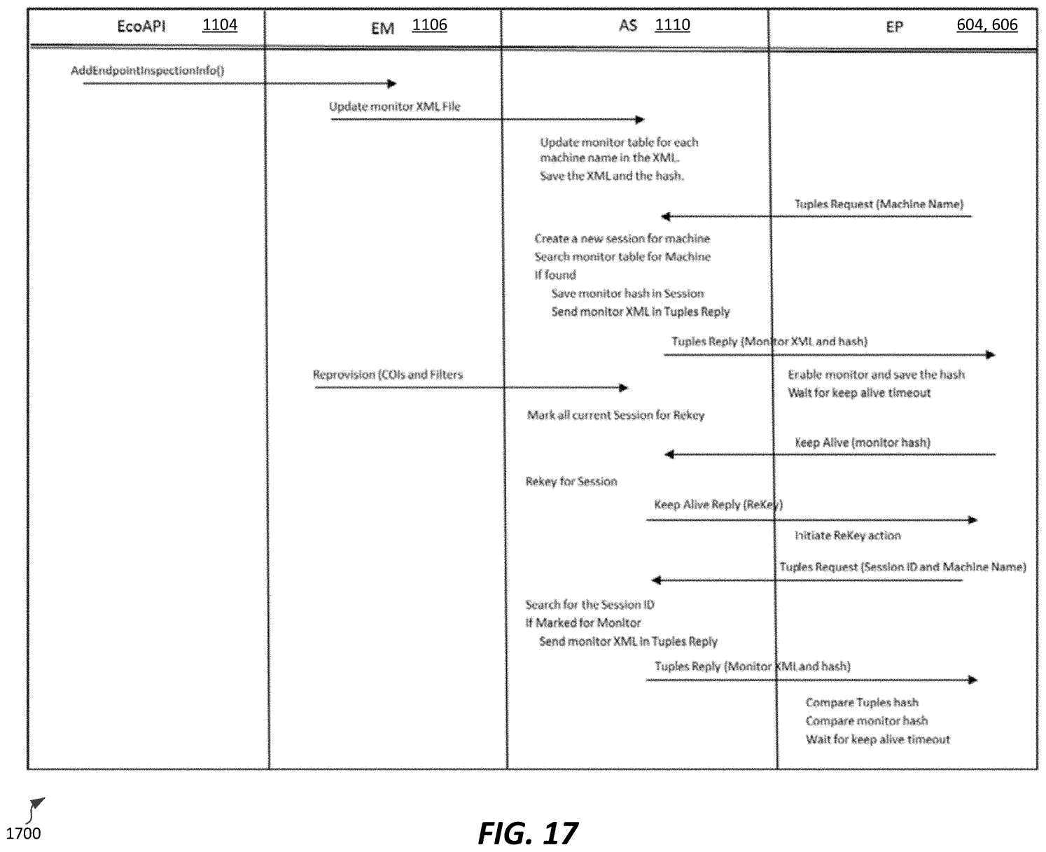

FIG. 17 is a message exchange sequence 1700 useable to re-key an endpoint and enable packet auditing within an enterprise network, according to an example embodiment. The rekey issued by the authorization service 1110 to the monitoring endpoint causes the endpoint to re-issue a Tuples Request using the existing session ID. This allows the authorization service 1110 to determine that the session includes a monitor hash and to include the monitor XML in the Tuples reply.

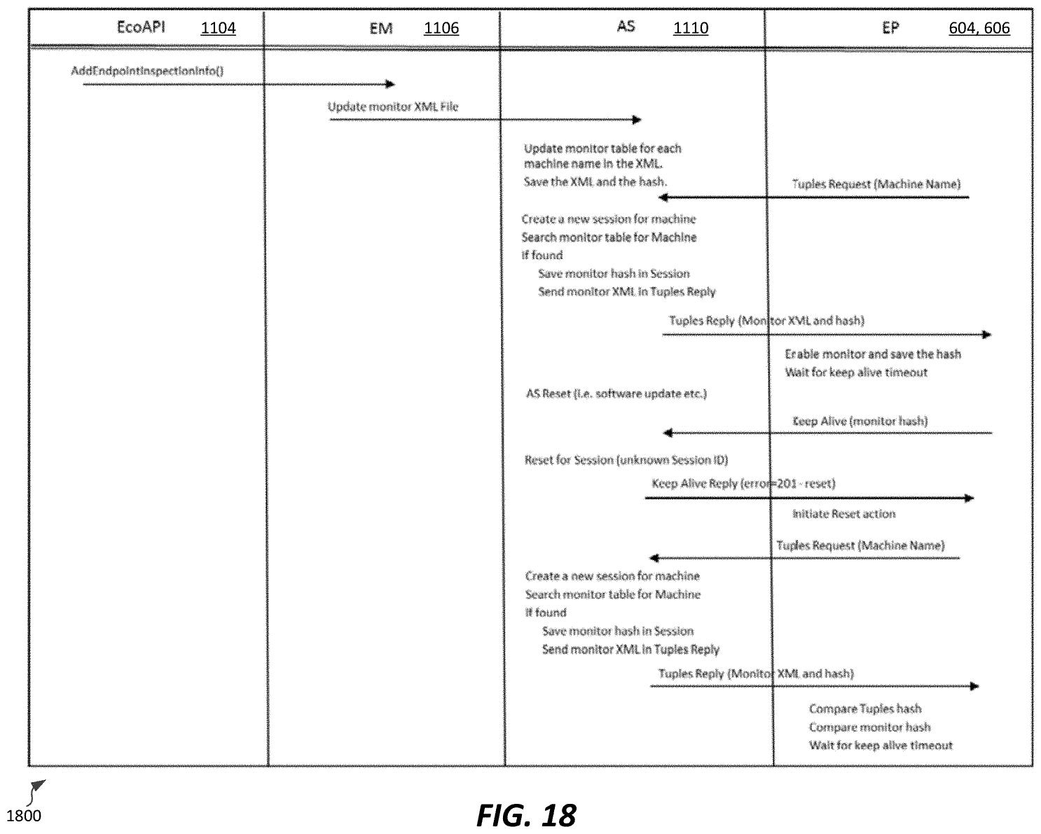

FIG. 18 is a message exchange sequence 1800 useable to reset an endpoint within an enterprise network, according to an example embodiment. When the authorization service 1110 is reset (i.e. due to a software upgrade or service restart), the monitoring endpoint receives the error code “201” and issues a new Tuples Request. The authorization service 1110 treats this request like any other new Tuples Request and searches the monitor table for the endpoint machine name. When it finds a match, it returns the monitor XML to the endpoint in the Tuples Reply.

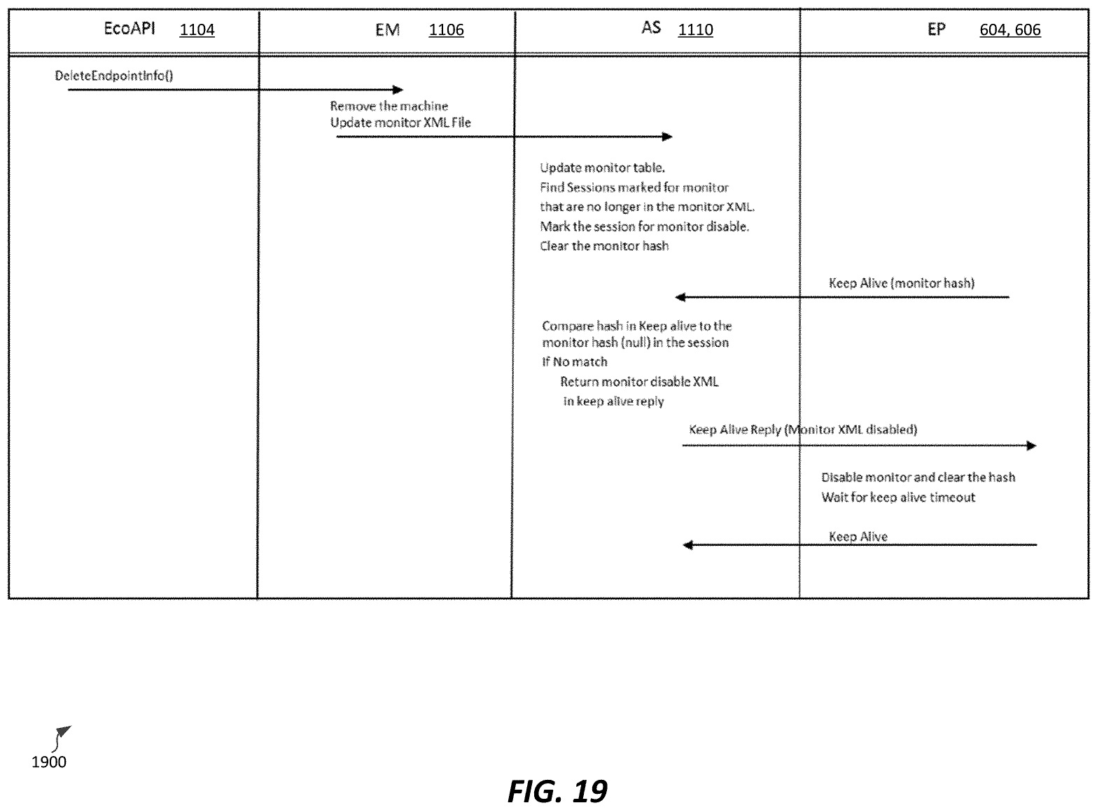

FIG. 19 is a message exchange sequence 1900 useable to disable packet copying and auditing at an endpoint within an enterprise network, according to an example embodiment. The ECO API 1104 invokes DeleteEndpointInfo using the machine name for the endpoint to be disabled. The enterprise management component 1106 generates a new monitor XML excluding the machine name for the XML and sends it to all known authorization services 1110. The authorization service 1110 processes the new monitor XML by following the same algorithm as described above in flow diagram 1500. As a result, endpoints that are no longer monitoring will have null hash values. On the next keep alive request from the endpoint the authorization service 1110 compares the monitor hash in the keep alive request to the session hash and finds that they do not match. The authorization service 1110 notes that the current monitor hash is NULL and returns a disable monitor XML in the keep alive reply to the endpoint. The endpoint then disables monitoring and all future keep alive requests do not contain the monitor hash.

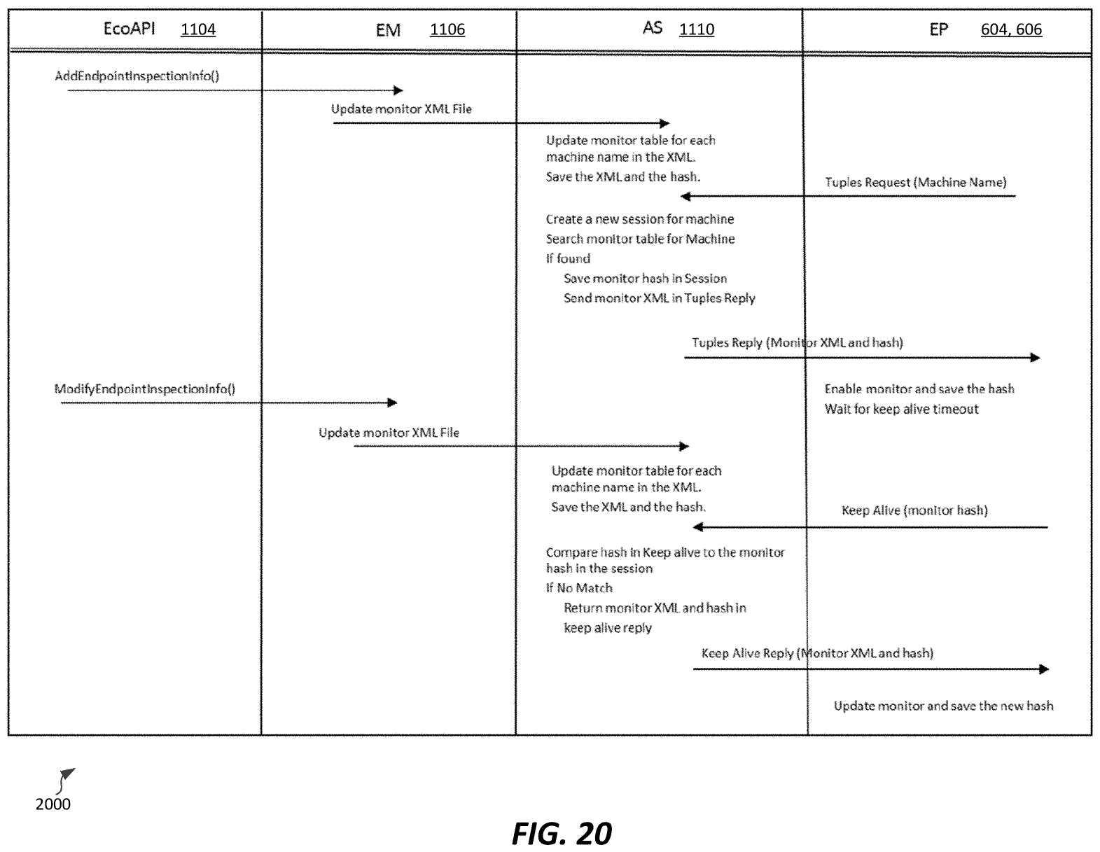

FIG. 20 is a message exchange sequence 2000 useable to modify settings associated packet copying and auditing at an existing endpoint within an enterprise network, according to an example embodiment. Once monitoring has been enabled on an endpoint, the monitor attributes can be modified (i.e. the delivery rate attributes via the ModifyEndpointInspectionInfo API. This results in the enterprise management component 1106 rebuilding the monitor XML and pushing the updated XML to all of the known authorization services 1110. The authorization service 1110 again follows its algorithm for updating sessions when the monitor XML is changed. In this case, the new hash value in the modified monitor XML replaces the old hash value in the session. When the next keep alive request is received from the endpoint, the hash no longer matches the hash in the session and the authorization service 1110 returns the new monitor XML in the keep alive reply. The endpoint updates its monitor information and reports the new hash in the next keep alive request.

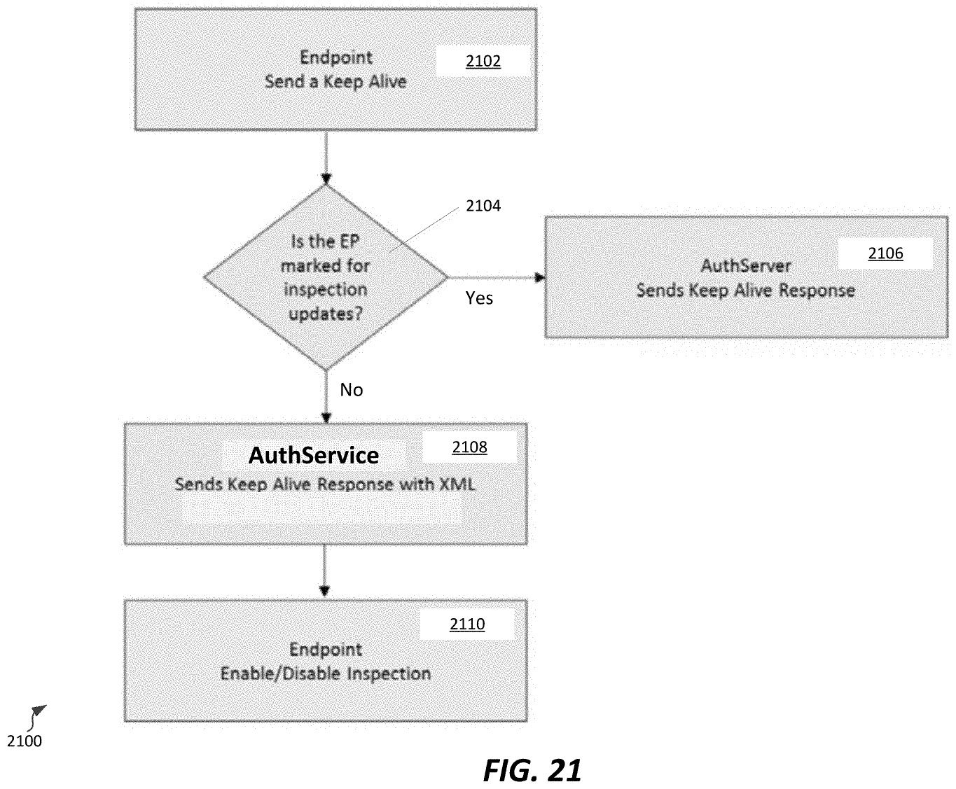

FIG. 21 is a flowchart of a method 2100 of updating and/or changing settings associated with packet auditing, according to example embodiments described herein. The method steps of FIG. 20 generalize the steps taken in connection with the message flow diagrams of FIGS. 15-20, and may occur between endpoints and the authorization service 1110. At step 2102, an endpoint, such as endpoints 604 or 606, sends a keep alive request to authorization service 1110. At step 2104, the authorization service 1110 determines whether the endpoint is designated to be updated, e.g. enabled via new endpoint session, enabled via existing endpoint session, enabled after a rekey, enabled after a reset, or disabled. If the endpoint is designated to be updated, the authorization service 1110 sends the appropriate keep alive response at step 2106. If the endpoint is not designated to be updated, the method proceeds to step 2108 in which the authorization service 1110 sends a keep alive response with the monitor XML to the endpoint. At step 2110, the endpoint then disables or enables packet auditing depending on the monitor XML contents.

In the examples shown in FIGS. 14-21, the monitor XML file is protected using both encryption and signing. A protection algorithm on both the enterprise management component 1106 and authorization service 1110 may be used. On the enterprise management component 1106, in general, the protection algorithm steps may include:
1. Generate a signing certificate with public (Sig.Pub) and private (Sig.Pri) key pair
2. Generate an AES 256 symmetric key (Sym) and 16 byte initialization vector (IV) for encryption.
3. Generate the <packetInspect> XML file
4. Insert the Sig.Pub key blob into a new element <SigKey>
   a. Add the <SigKey>
      i. key=“64 bit string of the public key blob Sig.Pub”
      ii. type=“cer”
      iii. use=“validate”
5. Encrypt the entire <xml . . . > file using the symmetric key Sym and IV
6. Convert the encrypted text to a 64 bit string
7. Create a new XML file with the root element <inspectFile>
8. Create and save a Master XML file
9. For each AS Server in the enterprise
   a. Create a new parent element <authServer machine=” machine name”>
   b. For each AS Group in the Server
      i. Store the IV and Sym in a single buffer
      ii. Encrypt the buffer (i) using the AS public key AS.Pub
      iii. Convert the encrypted data to a 64 bit string
      iv. Add the new child element <EncKey>
         1. key=“64 bit string from step ii”
         2. type=“aes”
         3. use=“encrypt”
         4. url=“AS Group URL”
10. Create a new element <inspectData> and add the 64 bit string from 5 as text for this element.
11. Sign the <fileInspect> XML using the signing certificate private key
12. Write the signed and encrypted XML to the directory

On the authorization service 1110, the protection algorithm steps may include:
1. Receive a signal when the file is written/updated
2. Locate the file and read the XML
3. Find the <authServer> element with a matching machine name.
4. Search the child elements <EncKey> for a matching url.
5. For the matching <Enckey>
   a. Convert the 64 bit string to binary
   b. Decrypt the key data using the AS private key
   c. Using the decrypted data import the AES Sym key to the key store and save the handle and save the 16 byte IV
6. Locate the <inspectData> element and retrieve the text for this element.
7. Convert the text from 64 bit string to binary.
8. Using the Sym key and IV decrypt the binary data
9. Load the clear text data into a new XML object
10. Locate the <SigKey> element and extract the text
11. Convert the 64 bit string in the text to binary
12. Load the binary data into a key blob and import the public key (Sig.Pub) into the machine certificate store (.cer)
13. Use the certificate to verify the signature on the original XML from step 2
14. If the signature is valid, process the XML from step 9
15. In all error paths, report an error and stop processing the file.

In the examples shown in FIGS. 14-21, standard XML signatures are used to sign and validate the monitor XML. A signing certificate is generated for the public key and stored in the monitor XML in a separate element, <SigKey>, that contains attributes which define the type and use for this particular certificate, as well as a base 64 string representation of the signing certificate object. A <packetInspect> element is then hashed, and its hash written as a <piKey>. The <SigKey> element, and all of its attributes, is encrypted along with the entire <inspect> XML using the AES symmetric key. An example of the

```
<packetInspect> XML format before encryption is:
<?xml version=“1.0” encoding=“utf-16”?>
<StealthDIMAdjunctSettings>
      <originalFileName>
      C:\Stealth Files\SoftwareInstalls\Packages\Adjunct-2017_09_13-18.01.13.xml
      </originalFileName>
      <version>L3.01</version>
      <dateTime>2017_09_13@18.01.13 UTC</dateTime>
      <packetInspect>
            <endPoints count=“3”>
                  <endPoint name=“Endpoint1”>
                        <monitor state=“enable” depth=“full” metadata=“none”
                        dark=“yes” cleartext=“yes” blocked=“yes” stealth=“yes”
                        hash=“p0nprWs6fdMFVjkthhWUPdfE/bXVy+tqJmlo43Xop1
                        mhYr6lkCyi76Cm” >
                              <PIEServer=“consumer1” />
                              <deliveryRate elapsedTimeMS=“3600000”
                              kilobytes=“100000”
                              packetCount=“100000” />
                        </monitor>
                  <endPoint name=“Endpoint2”>
                        <monitor state=“enable” depth=“full” metadata=“none”
                        dark=“yes” cleartext=“no” blocked=“no” stealth=“yes”
                        hash=“vcbns6fdMFVjktfgPdfE/bXVy+tqJmlo4fgYr6lkCyi76C
                        m”>
                              <PIEServer=“consumer2” />
                              <deliveryRate elapsedTimeMS=“3600000”
                              kilobytes=“100000” packetCount=“100000” />
                        </monitor>
                  </endPoint>
            </endPoints>
      </packetInspect>
      <piHash>3803A3F3DBEE59024E4C41F045CF64FBA40E4B57437CABC3A17BB1
      6DF08DBFCC50CD9013F7D5531127011F32DD5D3E6D894F13E1C3E55B6A16B
      E56A8B5C14734</piHash>
      <SigKey type=“cer”
      use=“validate”cert=“MIID1DCCAnygAwIBAgIQwdrD3RKGY15bivx.......Wy5NOJ9
      YQj3w=”/>
<StealthDIMAdjunctSettings>
```

In the examples shown in FIGS. 14-21, the <packetInspect> XML is encrypted and stored as text in the final <fileInspect> XML. The <piHash> element is added to the XML. The XML is then signed using the signing certificate private key and stored for authorization service(s) 1110 to read as shown in the following format example:

```
<?xml version=“1.0” encoding=“utf-16LE”?>
<ffleInspect>
      <authServers>
            <EncKey type=“aes” use=“encrypt” url=http://10.10.6.7:9200/
            key=“K61au0ubm/FmQ0ThH+fAtm8JwX/uCwj/Q6XF4UiZp1LkccTeYU71N
            W”/>
            <EncKey type=“aes” use=“encrypt” url=http://10.10.6.7:9400/
            key=“GlybixEQz1TeXNUZXN0LERDPWxyYz9jZXJ0aWZpY2FOZVJldm9j
            YXj8an”/>
            <EncKey type=“aes” use=“encrypt” url=http://10.10.7.8:9600/
            key=“wSBxDCBwTCBvqCBu6CBuIaBtWxkYXA6Ly8vQ049U3RlYXRoLU
            NBKDE”/>
            <EncKey type=“aes” use=“encrypt” url=http://10.10.7.8:9800/
            key=“tgphzHLUieooMbXykTyWW1yp13wu+u0acaw1HSR7elOpIW4/dCQ2
            z/ ”/>
      </authServer>
      <inspectData>64 bit string</inspectData>
<Signature xmlns=“http://www.w3.org/2000/09/xmldsig#”>
            - <SignedInfo>
                        <CanonicalizationMethod
                        Algorithm=“http://www.w3.org/2001/10/xml-exc-c14n#” />
                        <SignatureMethod
                        Algorithm=“http://www.w3.org/2000/09/xmldsig#rsa-sha1” />
                  - <Reference URI=“”>
                        - <Transforms>
                              <Transform
                              Algorithm=“http://www.w3.org/2000/09/xmldsig#envel
                              oped-signature□ />
                        </Transforms>
                        <DigestMethod
                        Algorithm=“http://www.w3.org/2000/09/xmldsig#sha1” />
                        <DigestValue>qPUJBRygZTxGuHPxJiXdtCnjJ04=</DigestVa
                        lue>
                  </Reference>
            </SignedInfo>
            <SignatureValue>mnQmBWwd8RKiyglAqgxL2HuCKX4MZp46swfRMeSC
            6pe5jj1Eb3jixQn9pudYzzssNJ2fYGxULu6ram4M7TfJBNcdxUcN/MpQu4V
            BU+4PWzvEn73I54I/vqP0MDzumYjkOLDkzDVv1mbGK51ZGp6aLXzZTF
            3p6xNocgWeUCnDkpaiXGigOLgicQ3t6704Rs85hUMuFMWNRKAveAB7js
            RBZdmpsGSkRSizIwIiH0N5c2PWl0rucJjWQAcPK2ZCA2lSLo2/ND9l6oio
            wbY+li0LRtyHxrlElSjHB6ZXbddKM+hrxjB8otUYg/Kd4TTHxVnRhylQo2q
            2Orgdha6osNq34g==
            </SignatureValue>
            - <KeyInfo/>
      </Signature>
</fileInspect>
```

In this format, the <piHash> element is the hash of the entire <packetInspect> element and can be used to determine if the content has changed since a prior XML. The <piHash> element it should not be trusted until the signature has been validated.

In some embodiments, a Configuration Audit Report (CAR) may be created to report the current monitoring or inspection configuration for an endpoint. In general, the enterprise management component 1106 defines whether packet auditing is to be enabled or disabled on an endpoint, based on ECO API 1104 requests. A CAR may be generated only if auditing is enabled on the endpoint. If auditing is enabled, the CAR is generated by the endpoint and sent to the authorization service 1110 from the endpoint every time the monitoring or inspection configuration for the endpoint changes. In some embodiments, the CAR may be sent periodically. An example CAR format is:

```
<?xml version=“1.0” encoding=“utf-16”?>
<audit version=”2” time=“20170908144601.853000-240” sequence=“5383” name=“Endpoint
Monitoring Configuration Report” audithash =
“p0nprWs6fdMFVjkthhWUPdfE/bXVy+tqJmlo43Xop1jwiZrOhDmhYr6lkCyi76Cm”>
<endpoint name=“T30-SARAH1” ipAddress=“192.168.9.5” stealthLevel=“3.5.0”
osArchitecture=“32-bit” osVersion=“Windows 7 Professional” modeType =
“ClientOnDemand” stealthMode=“Workgroup” stealthState = “Enabled” packageProfile =
“COD-Package” packageVersion=“1” packageID=“{ed8d6258-cf1f-4dda-
9af2d320650ee1c6}” baseID=“Unknown”>
<monitor state=“enable” depth=“full” metadata=“none” dark=“yes” cleartext = “yes”
blocked=“yes” stealth=“yes” >
      <PieServer name=“consumer1” />
      <deliveryRate elapsedTimeMS=“3600000” kilobytes=“100000”
      packetCount=“100000” />
      <IPAddress type=“IPv4” name=“192.158.233.10” >
            <protocol name=“TCP” >
                  <portLocalRemote localName=“*” remoteName=“*”/>
            </protocol>
      </IPAddress>
      <IPAddress type=“IPv4” name=“12.186.137.7” >
            <protocol name=“1”/>
      </IPAddress>
      <IPAddress type=“IPv4” name=“129.220.0.0/26” />
      <IPAddress type=“IPv4” name=“129.224.0.0/27” />
      <IPAddress type=“IPv4” name=“129.225.0.0/27” />
      <IPAddressRange type=“IPv4” lowName=“192.168.0.10” highName=“192.168.0.30”
      />
</monitor>
</endpoint>
</audit>
```

In some embodiments, the authorization service 1110 may also generate a monitor CAR each time it sends a new monitor XML to an endpoint. The endpoint CAR and the monitor CAR from the authorization service 1110 may be compared to ensure that the monitor attributes reported by both the endpoint and the authorization service 1110 match. An example monitor CAR format is:

```
<?xml version=“1.0” encoding=“utf-16”?>
<audit version =“2” time=20170908144601.853000-240” sequence=“5383”
name=“AuthServer Monitoring Configuration Report” audithash =
“p0nprWs6fdMFVjkthhWUPdfE/bXVy+tqJmlo43Xop1jwiZrOhDmhYr6lkCyi76Cm”>
      <endpoint name=“T30-SARAH1” ipAddress=“192.168.9.5” stealthLevel=“3.5.0”
      osArchitecture=“32-bit” osVersion=“Windows 7 Professional” modeType =
      “ClientOnDemand” stealthMode=“Workgroup” stealthState=“Enabled”
      packageProfile=“COD-Package” packageVersion=“1” packageID=“{ed8d6258-cf1f-
      4dda-9af2-d320650ee1c6}” baseID=“Unknown”>
            <authServer>
                  <monitor state=“enable” depth=“full” metadata=“none” dark=“yes”
                  cleartext=“yes” blocked=“yes” stealth=“yes” >
                        <PIEServer name=“consumer1” />
                        <deliveryRate elapsedTimeMS=“3600000”
                        kilobytes=“100000” packetCount=“100000” />
                        <IPAddress type=“IPv4” name=“192.158.233.10” >
                              <protocol name=“TCP” >
                                    <portLocalRemote localName=“*”
                                    remoteName=“*”/>
                              </protocol>
                        </IPAddress>
                        <IPAddress type=“IPv4” name=“12.186.137.7” >
                              <protocol name=“1”/>
                        </IPAddress>
                        <IPAddress type=“IPy4” name=“129.220.0.0/26” />
                        <IPAddress type=“IPv4” name=“129.224.0.0/27” />
                        <IPAddress type=“IPv4” name=“129.225.0.0/27” />
                        <IPAddressRange type=“IPv4” lowName=“192.168.0.10”
                        highName=“192.168.0.30” />
                  </monitor>
            </authserver>
      </endpoint>
</audit>
```

In some embodiments, the Authorization Server 1110 may reset or update its authorization groups. In this case, it is not necessary or desirable to re-encrypt all of the endpoint information, but only to rebuild the Monitor XML. Toward this end, when the Monitor XML is built, the key inspection data may be encrypted and stored in a Master XML file on the enterprise management component 1106 which may later be used to reconstruct the Monitor XML.

In some embodiments, regarding the enterprise management component 1106, the Monitor XML reconstruction algorithm steps are the same as for those when creating the Monitor XML except instead of Step “3. Generate the <packetInspect> XML file”, the algorithm may be:
3a. Read the Master XML file retrieving the Symmetric key, initialization vector and the inspection data
3b. Decrypt the Inspection data using the Symmetric key and initialization vector
3c. Use the Symmetric key to obtain the embedded key and verify the file signature
3d. Use the retrieved inspection data to generate the <packetInspect> XML file

An example Master XML file format is:

```
<?xml version=“1.0” encoding=“utf-16LE”?>
<masterFile>
      <enterpriseManager
            machine=“T30-Sarah-EM”
            type=“aes”
            use=“encrypt”
            key=“2CJicpKMOiQFF5Z8b/3G1/...”/>
      <inspectData>
            5c3v3LlNaG6WtRQC23IHMC1ehrCoaIXWDM9k3gsblLQzf12haVsLqeJi7Jh
            dBrOR33S/uWVYmxizkWc/RGEaE1iRsQ16CpmU9wjkHc2L8Zd5XkDGIf/
            ...
      </inspectData>
      <Signature xmlns=“http://www.w3.org/2000/09/xmldsig#”>
            <SignedInfo>
                  <CanonicalizationMethod
                        Algorithm=“http://www.w3.org/2001/10/xml-exc-c14n#”/>
                  <SignatureMethod Algorithm=
                        “http://www.w3.org/2000/09/xmldsig#rsa-sha1”/>
                  <Reference URI=“”>
                        <Transforms>
                              <Transform Algorithm=
                                    “http://www.w3.org/2000/09/xmldsig#envelope
                              d-signature”/>
                        </Transforms>
                        <DigestMethod Algorithm=
                              “http://www.w3.org/2000/09/xmldsig#sha1”/>
                        <DigestValue>
                              CsYaJWrJyJCP4x8M/n/4VNJi+9s=
                        </DigestValue>
                  </Reference>
            </SignedInfo>
            <SignatureValue>
                  l0wJOG9bEZ1xMIdBAek1Zn6rD9HWy3E5+...</SignatureValue>
            <KeyInfo>
      </Signature>
</masterFile>
```

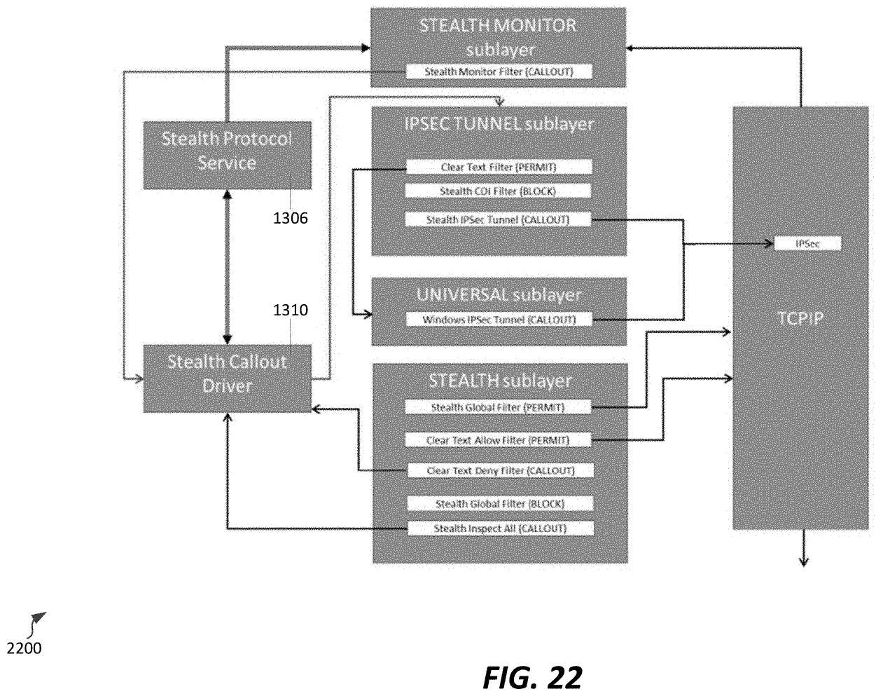

FIG. 22 is a block diagram of a network interface 2200 of a computing system useable within a consumer endpoint that is utilized within a secure enterprise network for packet receipt, modification, and forwarding, according to a possible embodiment. In some embodiments, similar architectures of other operating systems, e.g. Linux, may be used and are within the scope of the present disclosure. In general, the Stealth Windows agent is a collection of user level services that communicate with two kernel drivers: a callout driver 1310 used to enforce Stealth and a filter level driver 1316 used to bind to network adapters on the endpoint, as discussed above in connection with FIG. 13. The Stealth protocol is enforced by communications between the user level Stealth Protocol service 1306 and the Stealth callout driver 1310. The Windows Filtering Platform (WFP) is used to enforce the Stealth rules and build the IPSec policies used to enforce Stealth communications, clear text communications and blocked traffic on the endpoint.

The Stealth callout driver registers callout functions with WFP. When the driver's callout functions are invoked, the driver blocks the traffic and communicates with the Protocol service to initiate the SCIP protocol used to negotiate Stealth communications with the remote endpoint. The Protocol service adds filters to the WFP that are used to either callout traffic in the callout driver 1310, permit traffic as clear text, block traffic or callout traffic to be IPSec enabled.

On a Stealth enabled Windows endpoint, monitoring is performed via the Protocol service 1306 and the Stealth kernel level callout driver 1310. The Protocol service 1306 controls the monitoring by adding, modifying or removing the WFP filters used to monitor traffic. The Stealth callout driver 1310 implements the callout functions and gathers the traffic statistics for monitored traffic.

The callout driver 1310 does not have access to all of the metadata associated with the traffic, such as the COI. As such, the Protocol service 1306 will include information such as the COI, the authorized user, the OS type or software version when it communicates with the Stealth driver 1310 to open Stealth tunnels.

The callout driver 1310 is enhanced to include new callout functions and to save metadata associated with Stealth tunnels. This data is stored along with the inspected data to be forwarded by the callout driver 1310 to the consumer endpoint.

In order to enable monitoring of traffic the callout driver defines new callout functions to (1) callout, monitor and permit, (2) callout, monitor and block, and (3) callout, monitor and re-inject. For Stealth Packet Inspection the only required callout is the monitor and re-inject callout because all traffic is monitored regardless of the type of traffic and no metadata is required to identify the type of data to the packet inspection system 642.

The Protocol service 1306 adds filters to the WFP using these new callout functions for data that is to be monitored. The WFP filters are added in addition to the normal WFP filters used to permit, block or callout traffic, but they are added at a higher weight so that the WFP arbitration logic enforces the monitor filter first and then enforces the normal filter if/when data is re-injected by the callout driver. By adding multiple filters, monitoring can easily be disabled for specific traffic without having to remove all filters or close Stealth tunnels by simply removing the callout filters used for monitoring.

When a new callout function is invoked in the callout driver it copies the packet and queues the copied packet to a worker thread for processing. The work item indicates the monitoring action/type associated with the data. The callout function then blocks/discards the original packet.

The worker thread removes each packet from the queue and determines what action is required. Data is extracted from each packet and the packet is either blocked or re-injected by the worker thread. Packets that are re-injecting are marked as already inspected by this callout driver and will be called out again in the original callout function. The callout function detects that the packet has already been inspected and performs the specified action by either permitting or blocking the packet.

The packet auditing architecture 2200 shows the Stealth sublayers and filters used when monitoring or inspection is enabled on a Stealth Remove Packet Provider endpoint 604 or 606. The Stealth Monitor sublayer is used specifically for monitoring callout filters and is the highest possible weight allowed for any WFP sublayer.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

The above specification, examples and data provide a complete description of the manufacture and use of the composition of the invention. Since many embodiments of the invention can be made without departing from the spirit and scope of the invention, the invention resides in the claims hereinafter appended.

1. A method of auditing network data packets within a secure network, the method comprising:
receiving, at a consumer endpoint, packet data from a second endpoint, the packet data including at least a portion of a data packet, the packet data being encrypted with an encryption key associated with a packet auditing community of interest and having a routing header appended thereto, the routing header identifying the consumer endpoint;
decrypting the packet data using the encryption key associated with the packet auditing community of interest;
removing at least a portion of the routing header identifying the consumer endpoint from the decrypted packet data; and
performing at least one packet auditing operation on the decrypted packet data.

2. The method of claim 1, wherein the packet data includes the entire data packet, and wherein receiving the packet data from the second endpoint comprises receiving the packet data at a first network interface of the consumer endpoint.

3. The method of claim 2, further comprising:
appending, to the decrypted packet data, a hardware address of a second network interface of the consumer endpoint different from the first network interface, and appending a hardware address that can be used to identify traffic on the network; and
forwarding the decrypted packet data from the consumer endpoint to the network via the second network interface of the consumer endpoint;
wherein the second network interface is a dedicated clear text communication interface.

4. The method of claim 3, wherein appending the hardware address of the second network interface of the consumer endpoint comprises appending a media access control (MAC) address to the decrypted packet data.

5. The method of claim 2, wherein the packet data received from the second endpoint includes a plurality of data packets, and wherein the plurality of data packets include data transmitted or received by the second endpoint according to any of a plurality of communication protocols.

6. The method of claim 1, wherein the packet data received from the second endpoint includes headers and metadata of the data packet and less than the entire data packet.

7. The method of claim 6, wherein the packet data received from the second endpoint includes the headers and metadata of a plurality of data packets, and further wherein the plurality of headers and metadata of the plurality of data packets include data transmitted or received by the second endpoint according to any of a plurality of communication protocols.

8. The method of claim 1, wherein the packet data includes the contents of a second data packet sent or received by the second endpoint using an encryption key of a second community of interest different from the encryption key associated with the packet auditing community of interest.

9. The method of claim 1, further comprising:
transmitting, from a server, a message to the second endpoint enabling transmission of packet data to the consumer endpoint; and
transmitting, from a server, a message to the second endpoint changing a transmission characteristic of packet data to the consumer endpoint without interrupting transmission of the packet data.

10. A network data packet auditing system comprising:
a consumer endpoint including a programmable circuit communicatively connected to a memory storing a data packet routing service, wherein the data packet routing service, when executed by the programmable circuit, causes the consumer endpoint to:
receive packet data from a second endpoint, the packet data including at least a portion of a data packet, the packet data being encrypted with an encryption key associated with a packet auditing community of interest and having a routing header appended thereto, the routing header identifying the consumer endpoint;
decrypt the packet data using the encryption key associated with the packet auditing community of interest;
remove at least a portion of the routing header identifying the consumer endpoint from the decrypted packet data; and
perform at least one packet auditing operation on the decrypted packet data.

11. The network data packet auditing system of claim 10, wherein the packet data includes the entire data packet, and wherein receiving the packet data from the second endpoint comprises receiving the packet data at a first network interface of the consumer endpoint.

12. The network data packet auditing system of claim 11, wherein the data packet routing service further causes the consumer endpoint to:
appending a hardware address of a second network interface of the consumer endpoint different from the first network interface, and appending a hardware address that can be used to identify traffic on the network; and
forwarding the decrypted packet data from the consumer endpoint to the network via the second network interface of the consumer endpoint;
wherein the second network interface is a dedicated clear text communication interface.

13. The network data packet auditing system of claim 12, wherein appending the hardware address of the second network interface of the consumer endpoint comprises appending a media access control (MAC) address to the decrypted data packet.

14. The network data packet auditing system of claim 11, wherein the packet data received from the second endpoint includes a plurality of data packets, and wherein the plurality of data packets include data transmitted or received by the second endpoint according to any of a plurality of communication protocols.

15. The network data packet monitoring system of claim 10, wherein the packet data packet includes headers and metadata of the data packet.

16. The network data packet monitoring system of claim 10, wherein the packet data received from the second endpoint includes headers and metadata of a plurality of data packets, and further wherein the plurality of headers and metadata of the plurality of data packets include data transmitted or received by the second endpoint according to any of a plurality of communication protocols.

17. An enterprise security management network data packet auditing system comprising:
a secure application programming interface configured to receive messages to enable or disable network data packet auditing at any of a plurality of endpoints within an enterprise network including an enterprise security management system;
a database configured to store auditing configuration data;
an authorization server configured to enable or disable network data packet auditing on one or more of the plurality of endpoints within the enterprise network in response to messages received at the secure application programming interface; and
one or more consumer endpoints configured to decrypt encrypted packet data, the packet data including at least a portion of one or more data packets, received from endpoints and encrypted with a common community of interest key to form decrypted packet data, and perform at least one packet auditing operation on the decrypted packet data.

18. The enterprise security management network data packet auditing system of claim 17, further comprising one or more endpoints configured to copy packet data, encrypt copied packet data with the common community of interest key and send encrypted copied packet data to a consumer endpoint within the enterprise network in response to being enabled by the authorization server.

19. The enterprise security management network data packet auditing system of claim 17 further comprising a packet inspection server configured to inspect the modified decrypted data packets received from the one or more consumer endpoints, and wherein the one or more consumer endpoints are further configured to attach MAC headers to the decrypted packet data to form modified decrypted packet data, and send the modified decrypted packet data packets to the enterprise network via a dedicated clear text communication interface.

20. The enterprise security management network data packet auditing system of claim 18, wherein the one or more endpoints are further configured to transmit or receive packet data according to a plurality of communication protocols.

21. The enterprise security management network data packet auditing system of claim 18, further comprising an enterprise management server exposing the secure application programming interface and managing the database, the enterprise management server configured to receive network data packet auditing definition data via the secure application programming interface and cooperate with the authorization server to enable or disable network data packet auditing at selectable ones of the one or more endpoints.

22. The enterprise security management network data packet auditing system of claim 21, wherein the network data packet auditing definition data includes a definition of one or more endpoints selected to enable or disable network data packet auditing, a definition of whether entire or partial network data packets are forwarded from the one or more endpoints, a delivery rate of packets delivered to the packet auditing server, and a definition of an encryption condition of packet data copied at the one or more endpoints.
